(19) United States
(12) Patent Application Publication
(10) Pub. No.: US 2018/0333896 A1
(43) Pub. Date: Nov. 22, 2018

(54) PROCESSABLE POLYMERS AND METHODS OF MAKING AND USING

(71) Applicant: ZZYZX POLYMERS LLC, Allentown, PA (US)

(72) Inventors: Mark A. Tapsak, Bloomsburg, PA (US); Michael Janse, San Jose, CA (US); Binay Patel, Macungie, PA (US); Philip Brunner, East Stroudsburg, PA (US)

(21) Appl. No.: 15/989,668

(22) Filed: May 25, 2018

Related U.S. Application Data
(63) Continuation of application No. PCT/US17/26433, filed on Apr. 6, 2017.
(60) Provisional application No. 62/424,165, filed on Nov. 18, 2016.
(60) Provisional application No. 62/319,018, filed on Apr. 6, 2016.

(51) Int. Cl. B29B 9/02; C08L 23/12; B29B 9/12; B29B 13/02; B29B 13/04; C08L 23/06; C08L 25/06; C08L 27/06; C08L 27/18

(52) U.S. Cl. CPC B29B 9/02; C08L 23/12; B29B 9/12; B29B 13/02; B29C 47/0004; C08L 23/06; C08L 25/06; C08L 27/06; C08L 27/18; B29B 13/045

(57) ABSTRACT

Methods of transforming an ultra-high molecular weight polymer into a processable material and compositions resulting from those methods. The methods may include a combination of applying a shear force to a polymer and heating the polymer. Also described are methods for using the compositions.

### CONTINUING APPLICATION DATA

This application is a continuation of U.S. National Stage Application of International Application No. PCT/US2017/026433, filed Apr. 6, 2017, which claims the benefit of U.S. Provisional Application No. 62/319,018, filed Apr. 6, 2016, and U.S. Provisional Application No. 62/424,165, filed Nov. 18, 2016, each of which is incorporated by reference herein.

### GOVERNMENT FUNDING

This invention was made with government support under award number 1434826, awarded by the National Science Foundation. The government has certain rights in the invention.

### BACKGROUND

A polymer having a molecular weight less than about 7.5×10⁵ grams per mole (g/mol) may be processed in its melted state by a variety of common techniques. However, the melt viscosity of a polymer increases as its molecular weight increases, eventually reaching a point where the polymer will no longer flow like a liquid. Ultra-high molecular weight polymers, that is, those polymers having molecular weights of at least about 7.5×10⁵ g/mol, possess desirable properties including high tensile strength, a low coefficient of friction, high impact resistance and abrasion resistance. However, ultra-high molecular weight polymers possess very poor fluidity as compared to other commonly molded plastics, making them unamenable to conventional melt processing techniques.

A need exists for polymers having the processability of lower molecular weight polymers with the desirable properties of ultra-high molecular weight polymers.

### SUMMARY OF THE INVENTION

By performing the methods described herein an ultra-high molecular weight polymer may be transformed into a processable (for example, melt processable and/or injection moldable) material having ultra-high molecular weight-like properties. In some embodiments, ultra-high molecular weight-like properties include, for example, high tensile strength, toughness, a low coefficient of friction, high impact resistance, and/or abrasion resistance.

In one aspect, this disclosure describes a method that includes applying a shear force to a starting polymer composition including a polyolefin having a weight average molecular weight (M_{w}) of at least 7.5×10⁵ g/mol to form a sheared polymer composition.

In another aspect, this disclosure describes a method including: applying a shear force to a starting polymer composition including a polymer having a weight average molecular weight (M_{w}) of at least 7×10⁵ g/mol to form a sheared polymer composition; and treating the sheared polymer composition to form a processed polymer composition.

In yet another aspect, this disclosure describes a composition including a sheared polymer and/or a processed polymer.

In further aspects, this disclosure further describes methods of using compositions described herein, compositions obtained using the methods described herein, and articles formed from compositions described herein.

As used herein, “ultra-high molecular weight polymer” or “UHMW polymer” refers to a polymer having a weight average molecular weight of at least 7.5×10⁵ g/mol. In some embodiments, the polymer may have a weight average molecular weight of at least 1×10⁶ g/mol, at least 2×10⁶ g/mol, at least 4×10⁶ g/mol, at least 5×10⁶ g/mol, or at least 8×10⁶ g/mol.

As used herein, the term “melting” is defined as a phase transition of a material from a solid state to a softened state including, for example, the transition of a polymer material from a solid state to a softened, liquid, or near-liquid state. A “melting point” may be defined as a temperature at which the polymer material transitions from a solid state to a softened, liquid, or near-liquid state. For example, the melting point of ultra-high molecular weight polyethylene (UHMWPE) is typically in a range of 130 degrees Celsius (° C.) to 143° C. (266 degrees Fahrenheit (° F.) to 289° F.), depending on its molecular weight, but UHMWPE does not form a liquid at a temperature greater than its melting point. In some embodiments, a material's phase transition to a softened state may be observed using differential scanning calorimetry (DSC), and the temperature at which this transition occurs can be defined as the material's melting point.

As used herein, the “degradation temperature” is defined as the temperature at which there is 5% mass loss measured using thermogravimetric analysis while heating a sample of the material from 25° C. at a rate of 10° C. per minute under a nitrogen purge.

As used herein, unless otherwise specified, “molecular weight” for a polymer composition or polymer having a distribution of molecular weights is characterized by weight average molecular weight.

As used herein, “polydispersity index,” also referred to as “dispersity” or “PDI,” is equal to M_{w}/Mₙ, where M_{w} is the weight average molar weight and Mₙ is the number average molar weight. The larger the polydispersity index, the broader the molecular weight distribution.

As used herein, the “z average molecular weight,” also referred to as M_{z}, is defined by the following equation:

$${M}_{z} = \frac{Σ {N}_{i} {M}_{i}^{3}}{Σ {N}_{i} {M}_{i}^{2}}$$

where Mᵢ is the molecular weight of a polymer chain and Nᵢ is the number of chains of that molecular weight.

As used herein, unless otherwise specified, “melt flow index” values are provided in grams per 10 minutes as measured according to ASTM D1238-13 Procedure A at 190° C./2.16 kilogram (kg) using a heated 8 millimeter (mm) cylinder of 2.1 mm diameter.

As used herein, unless otherwise specified, “complex viscosity” values are provided in pascal-second (Pa·s), as measured using compression molded samples of 1 mm thickness and approximately 25 mm diameter on a rheometer equipped with a 25 mm diameter parallel plate assembly, at a frequency of 1×10⁻² radian per second (rad/s), a plate-to-plate gap of 1 mm, a temperature of 150° C. and an oscillatory strain of 1 percent (%), within the linear viscoelastic region of the polymer composition. The complex viscosity profile of a polymer composition over a range of frequencies may be indicative of the processability of the polymer composition as well as its overall melt and solid state mechanical properties.

As used herein, the term “contraction factor” or “g′” is a ratio obtained by dividing the intrinsic viscosity of a branched polymer by the intrinsic viscosity of a polymer having the same molecular weight and known to be linear. Unless otherwise indicated, contraction factor values herein were determined from data obtained using a viscosity detector during gel-permeation chromatography analysis, as described under the section entitled “Gel Permeation Chromatography (GPC)” for polymers in the sample having molecular weights (MW) in a range of 1×10⁴ g/mol to 1×10⁸ g/mol. The contraction factor may be indicative of the extent of branching because a highly branched polymer is less viscous, and often more processable, than a linear polymer of the same composition and molecular weight for a given shear rate. Therefore, a low contraction factor suggests that a polymer is highly branched.

As used herein, the term “melt processable” means having a melt flow index of at least 0.01 gram per 10 minutes and preferably at least 0.10 gram per 10 minutes. Unless otherwise indicated, the melt flow index is measured according to ASTM D1238-13 Procedure A at 190° C./2.16 kg using a heated 8 mm cylinder of 2.1 mm diameter.

The term “injection moldable” as used herein means that a composition may be injection molded into a Type I ASTM tensile test bar (ASTM D 638-02a) with a transfer pressure of up to 140 megapascal (MPa) (20,305 pounds per square inch (psi)), a melt temperature of up to 300° C. (572° F.), a mold temperature of up to 60° C. (140° F.), and a fill time of under 3 seconds, and preferably a fill time of under 1 second.

As used herein, “room temperature” is defined as a temperature in a range of 18° C. to 28° C.

As used herein, a “gel solvent” includes a solvent used during gel processing and/or during the fractionation of a polymer.

As used herein, a “gel solvent residue” is defined as solvent used during gel processing and/or during the fractionation of a polymer that remains in the polymer after gel processing and/or after fractionation is complete.

The words “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

The terms “comprises” and variations thereof do not have a limiting meaning where these terms appear in the description and claims. Such terms will be understood to imply the inclusion of a stated step or element or group of steps or elements but not the exclusion of any other step or element or group of steps or elements. By “consisting of” is meant including, and limited to, whatever follows the phrase “consisting of.” Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they materially affect the activity or action of the listed elements.

Unless otherwise specified, “a,” “an,” “the,” and “at least one” are used interchangeably and mean one or more than one.

Also herein, the recitations of numerical ranges by endpoints include all numbers subsumed within that range (for example, 1 to 5 includes 1, 1.5, 2, 2.75, 3, 3.80, 4, 5, etc.).

For any method disclosed herein that includes discrete steps, the steps may be conducted in any feasible order. And, as appropriate, any combination of two or more steps may be conducted simultaneously.

Unless otherwise indicated, all numbers expressing quantities of components, molecular weights, and so forth used in the specification and claims are to be understood as being modified in all instances by the term “about.” Accordingly, unless otherwise indicated to the contrary, the numerical parameters set forth in the specification and claims are approximations that may vary depending upon the desired properties sought to be obtained by the present invention. At the very least, and not as an attempt to limit the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. All numerical values, however, inherently contain a range necessarily resulting from the standard deviation found in their respective testing measurements.

The above summary of the present invention is not intended to describe each disclosed embodiment or every implementation of the present invention. The description that follows more particularly exemplifies illustrative embodiments. In several places throughout the application, guidance is provided through lists of examples, which examples may be used in various combinations. In each instance, the recited list serves only as a representative group and should not be interpreted as an exclusive list.

### BRIEF DESCRIPTION OF THE FIGURES

FIG. 1 shows a process flow diagram of some embodiments including a first extruder and a second extruder. The material resulting from step 2 is a “sheared polymer;” the material resulting from step 5 is a “processed polymer.”

FIG. 2 shows an embodiment of the operating conditions of a first extruder.

FIG. 3 shows an embodiment of the operating conditions of a second extruder.

FIG. 4(A-B) shows stress versus strain curves for the compression molded polyethylene of Example 1 and the processed polyethylene of Examples 2 to 5. FIG. 4A shows the curves where the elongation has a range of 0% to 600%. FIG. 4B shows a portion of the same curves where the elongation has a range of 0% to 100%.

FIG. 5 shows a differential scanning calorimetry scan for the compression molded polyethylene of Example 1 (top panel) and the processed polyethylene of Example 4 (bottom panel).

FIG. 6(A-B) shows spectra from Fourier transform infrared spectroscopy (FTIR) scans of a compression molded film of the polyethylene of Example 1 (FIG. 6A) and an injection molded disk of the processed polyethylene of Example 4 (FIG. 6B). Physical properties for these examples are provided in Table 1.

FIG. 7 shows a process flow diagram of some embodiments including a first extruder.

FIG. 8 shows gel permeation chromatography (GPC) data for the polymer materials of Examples 2, 4, 52, and 53.

FIG. 9 shows stress versus strain curves for the polymer materials of Examples 52 to 54.

FIG. 10 shows torsional rheology data for the polymer materials of Examples 52 to 54.

FIG. 11 shows small angle oscillatory shear for the polymer materials of Examples 2 and 4.

### DETAILED DESCRIPTION

The present disclosure describes methods of transforming an ultra-high molecular weight polymer into a processable (for example, melt processable and/or injection moldable) material having ultra-high molecular weight-like properties. In some embodiments, ultra-high molecular weight-like properties include, for example, high tensile strength, toughness, a low coefficient of friction, high impact resistance, and/or abrasion resistance. The methods include applying shear force to a starting polymer composition to form a sheared polymer composition. In some embodiments, the methods further include treating the sheared polymer composition to form a processed polymer composition. Treating the sheared polymer composition to form a processed polymer composition may include heating the sheared polymer composition or applying shear force to the sheared polymer composition, or both. The present disclosure also provides compositions that include the sheared polymer and/or the processed polymer, methods of using those compositions, and articles formed from those compositions.

### Methods of Making

The present disclosure provides methods of applying a shear force to a starting polymer composition to form a sheared polymer composition. The starting polymer composition includes a polymer having a molecular weight of at least 7.5×10⁵ g/mol or at least 1×10⁶ g/mol. The present disclosure also provides methods of treating the sheared polymer composition to form a processed polymer composition. In many embodiments, it is preferred that the processed polymer composition has a melt flow index of at least 0.01 and preferably at least 0.10.

The methods described herein produce compositions that include polymer chains having a narrow molecular weight distribution around the highest average molecular weight possible to achieve a given melt viscosity target. These compositions exhibit the processability of a lower molecular weight plastic (including, for example, melt processability and/or injection moldability) and the desirable properties of a higher molecular weight plastic including, for example, high tensile strength, toughness, a low coefficient of friction, high impact resistance, and/or abrasion resistance. In some embodiments, the compositions may exhibit resistance to corrosive chemicals. In contrast, materials that include a broad molecular weight distribution contain very long polymer chains that may limit melt flow under shear; this broad molecular weight distribution greatly restricts the processability and moldability of the material.

In some embodiments, the methods described herein include high temperature melt mixing, that is melt mixing at a temperature well above (that is, greater than) the melting point of a polymer. Such temperatures are typically avoided to reduce harmful effects on physical properties of the polymer. As described herein, however, heating a sheared polymer composition to a temperature well above its melting point while, optionally, applying shear stress may selectively decrease M_{w} and Mₙ, permitting the improved processability of the composition while maintaining desirable properties normally associated with a higher molecular weight plastic.

In one aspect, this disclosure describes a method that includes applying a shear force to a starting polymer composition to form a sheared polymer composition. In some embodiments, the starting polymer composition includes a polymer having a weight average molecular weight of at least 7.5×10⁵ g/mol, at least 1×10⁶ g/mol, at least 2×10⁶ g/mol, at least 3×10⁶ g/mol, at least 4×10⁶ g/mol, at least 5×10⁶ g/mol, at least 6×10⁶ g/mol, at least 7×10⁵ g/mol, or at least 8×10⁶ g/mol.

The starting polymer composition may include any suitable polymer or combination of polymers where at least one of the polymers has a molecular weight of at least 7.5×10⁵ g/mol. In some embodiments, at least one of the polymers has a molecular weight of at least 1×10⁶ g/mol, at least 2×10⁶ g/mol, at least 3×10⁶ g/mol, at least 4×10⁶ g/mol, at least 5×10⁶ g/mol, at least 6×10⁶ g/mol, at least 7×10⁶ g/mol, or at least 8×10⁶ g/mol. In some embodiments, at least one of the polymers has a molecular weight of up to 8×10⁶ g/mol, up to 9×10⁶ g/mol, or up to 10×10⁶ g/mol. In some embodiments the polymer includes a polyolefin including, for example, a polyethylene and/or a polypropylene; a polytetrafluoroethylene; a polystyrene; a polyvinylchloride; or a polyester; or a combination thereof (for example, mixtures and copolymers thereof). In some embodiments, the polymer preferably includes a polyolefin. In some embodiments, the polymer is a polyolefin. In some embodiments the polymer preferably includes a polyethylene.

In some embodiments, the starting polymer composition includes at least 50 wt % polymer having a molecular weight of at least 7.5×10⁵ g/mol, at least 60 wt % polymer having a molecular weight of at least 7.5×10⁵ g/mol, at least 70 wt % polymer having a molecular weight of at least 7.5×10⁵ g/mol, at least 80 wt % polymer having a molecular weight of at least 7.5×10⁵ g/mol, at least 90 wt % polymer having a molecular weight of at least 7.5×10⁵ g/mol, at least 95 wt % polymer having a molecular weight of at least 7.5×10⁵ g/mol, or at least 99 wt % polymer having a molecular weight of at least 7.5×10⁵ g/mol. In some embodiments the starting polymer composition consists essentially of a polymer having a molecular weight of at least 7.5×10⁵ g/mol, wherein “consists essentially of” indicates that the polymer composition does not contain a sufficient amount of another material to increase the melt flow index of the polymer composition from 0 to at least 0.01. In some embodiments the polymer composition consists of a polymer having a molecular weight of at least 7.5×10⁵ g/mol.

The starting polymer composition may include, for example, a polyethylene having a molecular weight of at least 7.5×10⁵ g/mol, a polytetrafluoroethylene having a molecular weight of at least 7.5×10⁵ g/mol, a polypropylene having a molecular weight of at least 7.5×10⁵ g/mol, a polystyrene having a molecular weight of at least 7.5×10⁵ g/mol, a polyvinylchloride having a molecular weight of at least 7.5×10⁵ g/mol, or a polyester having a molecular weight of at least 7.5×10⁵ g/mol, or a combination thereof (for example, mixtures and copolymers thereof).

In some embodiments, it is preferred that the starting polymer composition includes polyethylene having a molecular weight of at least 7.5×10⁵ g/mol. In some embodiments, the starting polymer composition may consist essentially of polyethylene having a molecular weight of at least 7.5×10⁵ g/mol. In some embodiments, the starting polymer composition may consist of polyethylene having a molecular weight of at least 7.5×10⁵ g/mol. In some embodiments, the polyethylene has a molecular weight at least 7.5×10⁵ g/mol, at least 1×10⁶ g/mol, at least 2×10⁶ g/mol, at least 4×10⁶ g/mol, at least 5×10⁶ g/mol, or at least 8×10⁶ g/mol. In some embodiments, the polyethylene has a molecular weight of up to 8×10⁶ g/mol, up to 9×10⁶ g/mol, or up to 10×10⁶ g/mol.

In some embodiments the starting polymer composition preferably does not include a sufficient quantity of a gel solvent to increase the melt flow index of the starting polymer composition to at least 0.01. In some embodiments the starting polymer composition preferably does not include a sufficient quantity of gel solvent to alter the melt flow index of the sheared polymer composition to at least 0.01.

In some embodiments, the starting polymer composition may further include a polymer having a molecular weight of less than 7.5×10⁵ g/mol. The polymer having a molecular weight of less than 7.5×10⁵ g/mol may include any suitable polymer or polymers including, for example, one or more of high density polyethylene (HDPE), linear low density polyethylene (LLDPE), low density polyethylene (LDPE), medium density polyethylene (MDPE), high molecular weight polyethylene (HMWPE), ultra-high molecular weight polyethylene (UHMWPE), polyethylene wax (PE wax), cross-linked polyethylene (XLPE), polypropylene (PP), nylon, polyethylene terephthalate (PET), thermoplastic polyurethane (TPU), a thermoplastic elastomer (TPE), polyvinyl chloride (PVC), polytetrafluoroethylene (PTFE), polyoxymethylene (POM), polycarbonate (PC), polysulfone (PSU), polyetherimide (PEI), polyethersulfone (PES), polystyrene (PS), polymethylmethacrylate (PMMA), polyetheretherketone (PEEK), or polybutylene terephthalate (PBT).

In some embodiments it is preferred that the amount of a polymer having a molecular weight of less than 7.5×10⁵ g/mol in a polymer composition is not sufficient to achieve a melt flow index of at least 0.01 through blending or mixing alone.

In some embodiments, a polyethylene having a molecular weight of at least 7.5×10⁵ g/mol may be blended during a subsequent processing step or added during the process. In some embodiments, one or more secondary polymers may be blended during a subsequent processing step or added during the process. The secondary polymer or polymers may include any suitable polymer or polymers including, for example, one or more of high density polyethylene (HDPE), polypropylene (PP), nylon, polyethylene terephthalate (PET), thermoplastic polyurethane (TPU), a thermoplastic elastomer (TPE), polyvinyl chloride (PVC), polytetrafluoroethylene (PTFE), polyoxymethylene (POM), polycarbonate (PC), polysulfone (PSU), polyetherimide (PEI), polyethersulfone (PES), polystyrene (PS), polymethylmethacrylate (PMMA), polyetheretherketone (PEEK), or polybutylene terephthalate (PBT).

In some embodiments, when the starting polymer composition includes a polymer having a molecular weight of up to 7.5×10⁵ g/mol and one or more additional polymers having a molecular weight of at least 7.5×10⁵ g/mol, the polymers may be blended before, during, or after applying shear force to form a sheared polymer. In some embodiments, a polymer having a molecular weight of up to 7.5×10⁵ g/mol and one or more additional polymers having a molecular weight of at least 7.5×10⁵ g/mol may be blended with a single or twin-screw melt extruder.

In some embodiments, the starting polymer composition and/or the sheared polymer composition may include an additive. An additive (which also may be referred to as an adjuvant) may include, for example, a filler (an organic filler and/or an inorganic filler), a thermal and/or a UV stabilizer, an antioxidant, a dye, a pigment, a colorant, an oil, or a lubricant, or a combination thereof. In some embodiments it is preferred that the additive included in the starting polymer composition is included in an amount that does not increase the melt flow index of the processed polymer to at least 0.01. In some embodiments, a processed polymer composition that includes a polymer and an additive may have the same melt flow index as a processed polymer composition that includes only a polymer having a molecular weight of at least 7.5×10⁶ g/mol.

Optionally, any suitable thermal and/or UV stabilizer may be included in the starting polymer composition or may be added during the process, including, for example, one or more of the following: 4-Allyloxy-2-hydroxybenzophenone; 1-Aza-3,7-dioxabicyclo[3.3.0]octane-5-methanol; 2-(2H-Benzotriazol-2-yl)-4,6-bis(1-methyl-1-phenylethyl)phenol; 2-(2H-Benzotriazol-2-yl)-4,6-di-tert-pentylphenol; 2-(2H-Benzotriazol-2-yl)-6-dodecyl-4-methylphenol; 2-[3-(2H-Benzotriazol-2-yl)-4-hydroxyphenyl]ethyl methacrylate; 2-(2H-Benzotriazol-2-yl)-4-methyl-6-(2-propenyl)phenol; 2-(2H-Benzotriazol-2-yl)-4-(1,1,3,3-tetramethylbutyl)phenol; 2-(4-Benzoyl-3-hydroxyphenoxy)ethyl acrylate; 3,9-Bis(2,4-dicumylphenoxy)-2,4,8,10-tetraoxa-3,9-diphosphaspiro[5.5]undecane; Bis(octadecyl)hydroxylamine; 3,9-Bis(octadecyloxy)-2,4,8,10-tetraoxa-3,9-diphosphaspiro[5.5]undecane; Bis(1-octyloxy-2,2,6,6-tetramethyl-4-piperidyl) sebacate; Bis(2,2,6,6-tetramethyl-4-piperidyl) sebacate; 2-tert-Butyl-6-(5-chloro-2H-benzotriazol-2-yl)-4-methylphenol; 2-tert-Butyl-4-ethylphenol; 5-Chloro-2-hydroxybenzophenone; 5-Chloro-2-hydroxy-4-methylbenzophenone; 2,4-Di-tert-butyl-6-(5-chloro-2H-benzotriazol-2-yl)phenol; 2,6-Di-tert-butyl-4-(dimethylaminomethyl)phenol; 3′,5′-Dichloro-2′-hydroxyacetophenone; Didodecyl 3,3′-thiodipropionate; 2,4-Dihydroxybenzophenone; 2,2′-Dihydroxy-4,4′-dimethoxybenzophenone; 2,2′-Dihydroxy-4-methoxybenzophenone; 2′,4′-Dihydroxy-3′-propylacetophenone; 2,3-Dimethylhydroquinone; 2-(4,6-Diphenyl-1,3,5-triazin-2-yl)-5-[(hexyl)oxy]-phenol; 5-Ethyl-1-aza-3,7-dioxabicyclo[3.3.0]octane; Ethyl 2-cyano-3,3-diphenylacrylate; 2-Ethylhexyl 2-cyano-3,3-diphenylacrylate; 2-Ethylhexyl trans-4-methoxycinnamate; 2-Ethylhexyl salicylate; 2,2′-Ethylidene-bis(4,6-di-tert-butylphenol); 2-Hydroxy-4-(octyloxy)benzophenone; Menthyl anthranilate; 2-Methoxyhydroquinone; Methyl-p-benzoquinone; 2,2′-Methylenebis[6-(2H-benzotriazol-2-yl)-4-(1,1,3,3-tetramethylbutyl)phenol]; 2,2′-Methylenebis(6-tert-butyl-4-ethylphenol); 2,2′-Methylenebis(6-tert-butyl-4-methylphenol); 5,5′-Methylenebis(2-hydroxy-4-methoxybenzophenone); Methylhydroquinone; 4-Nitrophenol sodium salt hydrate; Octadecyl 3-(3,5-di-tert-butyl-4-hydroxyphenyl)propionate; Pentaerythritol tetrakis(3,5-di-tert-butyl-4-hydroxyhydrocinnamate); 2-Phenyl-5-benzimidazolesulfonic acid; Poly[[6-[(1,1,3,3-tetramethylbutyl)amino]-s-triazine-2,4-diyl]-[(2,2,6,6-tetramethyl-4-piperidyl)imino]-hexamethylene-[(2,2,6,6 -tetramethyl-4-piperidyl)imino]; Sodium D-isoascorbate monohydrate; Tetrachloro-1,4-benzoquinone; Triisodecyl phosphite; 1,3,5-Trimethyl-2,4,6-tris(3,5-di-tert-butyl-4-hydroxybenzyl)benzene; Tris(4-tert-butyl-3-hydroxy-2,6-dimethylbenzyl) isocyanurate; Tris(2,4-di-tert-butylphenyl) phosphite; Tris(2,4-di-tert-butylphenyl) phosphite; Tris(nonylphenyl) phosphite.butylphenyl) phosphite; Tris(nonylphenyl) phosphite.

In some embodiments, any suitable antioxidant may be included in the starting polymer composition or may be added during the process, including, for example, solid and liquid primary and secondary antioxidants such as those available from Adeka Palmarole under the name ADK STAB. In some embodiments, the antioxidant may be phenolic, phosphorus based, or sulfur based.

In some embodiments, any suitable colorant may be included in the starting material or added during the process, including, for example, any conventional inorganic and organic pigments, organic dyestuff, or carbon black. A colorant may be used, for example, in amounts of up to 1 wt %, up to 3 wt %, up to 5 wt %, up to 10% of the polymer composition, and/or in amounts useful to achieve desired color characteristic. Those skilled in the art also will be aware of suitable pigments, organic pigments, and dyestuffs useful as colorants. Such materials described, for example, in Kirk-Othmer Encyclopedia of Chemical Technology, Third Edition, Vol 6. Pages 597-617; examples include but are not limited to:
Inorganic types such as titanium dioxide, carbon black, iron oxide, zinc chromate, cadmium sulfides, chromium oxides, sodium aluminum silicate complexes, such as ultramarine pigments, metal flakes and the like; and
Organic pigments such as azo and diazo pigments, phthalocynanines, quinarcridone pigments, perylene pigments, isoindoline, anthraquinones, thioindigo, and the like. Other additives or mixtures thereof may also be included in the colorant polymer mixture such as, for example, lubricants, antistatic agents, impact modifiers, antimicrobials, light stabilizers, filler/reinforcing materials (for example, CaCO₃), heat stabilizers, release agents, rheological control agents such as clay, etc.
   The colorants and/or other additives may be incorporated in combinations and/or amounts known by those skilled in the art to achieve the desired effect.

In some embodiments, any suitable organic filler may be included in the starting polymer composition or added during the process, including, for example, cellulose, rice husk ash, lignin, grape seeds, coconut fiber, any solid organic wastes, post-consumer refuse, agricultural and manufacturing by-products, and combinations thereof.

In some embodiments, any suitable inorganic filler may be included in the starting polymer composition or added during the process. The inorganic filler may include, for example, talc, silica, copper, aluminum, brass, tin, glass fiber, a nitrate, a bromide based flame retardant, an antimicrobial agent, an oxygen scavenger, unmodified and/or modified clay, unmodified and/or modified graphite, graphene, single or multi-walled carbon nanotubes, or any combination of filler and/or nanofiller.

In some embodiments, the first step includes applying a specific energy of at least 0.1 kilowatt-hour per kilogram (kw*hr/kg), at least 0.2 kw*hr/kg, at least 0.3 kw*hr/kg, at least 0.4 kw*hr/kg, at least 0.5 kw*hr/kg, at least 0.6 kw*hr/kg, at least 0.8 kw*hr/kg, or at least 1 kw*hr/kg to the starting polymer composition. In some embodiments, the specific energy applied may be up to 0.4 kw*hr/kg, up to 5 kw*hr/kg, up to 10 kw*hr/kg, or up to 20 kw*hr/kg.

In some embodiments, the first step includes applying a shear rate of at least 25 reciprocal seconds (sec⁻¹), at least 50 sec⁻¹, at least 100 sec⁻¹, at least 250 sec⁻¹, at least 500 sec⁻¹, or at least 1,000 sec⁻¹. In some embodiments, the shear rate applied may be up to 5000 sec⁻¹, up to 10,000 sec⁻¹, up to 25,000 sec⁻¹, or up to 50,000 sec⁻¹.

In some embodiments, applying shear force to the starting polymer composition including applying a shear force at a temperature less than the melting point of the starting polymer composition. For example, for a starting polymer composition including ultra-high molecular weight polyethylene, applying shear force to the starting polymer composition could be performed at a temperature less than the melting point of the polyethylene, which is typically in a range of 130° C. to 143° C. (266° F. to 289° F.). For a starting polymer composition including more than one ultra-high molecular weight polymer, applying shear force to the starting polymer composition may, in some embodiments, be performed at a temperature less than the lowest melting point of each of the polymers in the composition, or less than the melting point of the polymer which forms the major constituent of the composition.

In some embodiments, applying shear force to the starting polymer composition includes applying a shear force at a temperature greater than the melting point of the polymer composition. Ultra-high molecular weight polymers may remain highly viscous, even at a temperature greater than their melting point and up to their degradation temperature. Therefore, high mechanical force, high specific energy, and/or high shear force may be applied to ultra-high molecular weight polymers that are processed at a temperature greater than their melting point. For example, for a starting polymer composition including ultra-high molecular weight polyethylene, applying shear force to the polymer composition may be performed at a temperature greater than the melting point of the polyethylene, which is typically around 130° C. to 143° C. (266° F. to 289° F.). For a starting polymer composition including more than one ultra-high molecular weight polymer, applying shear force to the starting polymer composition may, in some embodiments, be performed at a temperature greater than the temperature of the melting point of the lowest melting point of the polymers in the composition, or greater than the temperature of the melting point of the polymer which forms the major constituent of the composition. In some embodiments, applying shear force to the polymer composition includes applying a shear force at a process set temperature of up to 25° C., up to 30° C., up to 40° C., up to 50° C., up to 60° C., up to 70° C., up to 80° C., up to 90° C., up to 100° C., up to 110° C., up to 120° C., up to 130° C., up to 140° C., up to 150° C., up to 160° C., up to 170° C., up to 200° C., up to 300° C., up to 400° C., or up to 500° C.

It is understood that when polymeric materials are being processed as described herein, stated process set temperatures may not always reflect instantaneous and localized material temperatures. This difference is because heat generated within machine regions by high shear forces may temporarily raise the material's temperature to a temperature greater than the process set temperatures. Subsequently, the material may then cool back down to a temperature less than this temporarily elevated temperature. By the very nature of this continuous process, the minor heating and cooling changes could occur repeatedly so that overall the average temperature is held at the process set point.

In some embodiments, applying a shear force includes exposing the starting polymer composition to a mixer. A mixer may include, for example, a single screw extruder, a twin screw extruder, an extruder having more than two screws (for example, a triple screw extruder or a quadruple screw extruder), a turbo blender, a higher shear mixer, a high shear inline mixer, and a high-shear granulator. It is understood that the mixer may have many variables in its operation. Parameters such as mixing shaft revolutions per minute (rpm), barrel to element tolerances, and the viscosity of the material being processed all play a role in imparting specific energy or shear force into the processed material. It is understood that these parameters may be selected by a skilled artisan.

In some embodiments, a mixer satisfactory for carrying out the process of the invention is a high-shear mixing extruder produced by Werner & Pfleiderer, Germany. The Werner & Pfleiderer (WP) extruder is a twin-shaft screw extruder in which two intermeshing screws rotate in the same direction. Details of such extruders are described in U.S. Pat. Nos. 3,963,679 and 4,250,292; and German Pat. Nos. 2,302,546; 2,473,764; and 2,549,372. Screw diameters vary from 53 mm to 300 mm; barrel lengths vary but generally the maximum barrel length is the length necessary to maintain a length over diameter ratio of 42. The shaft screws of these extruders normally are made-up of alternating series of conveying sections and pulverizing sections. The conveying sections cause material to move forward from each pulverizing section of the extruder. Pulverizing elements containing one, two, three, or four tips are suitable, however, pulverizing elements 5 mm to 30 mm wide having two tips are preferred. At recommended screw speeds in a range of 100 rpm to 600 rpm and radial clearance of 0.1 to 0.4 mm, these mixing extruders provide shear rates of at least 500 sec⁻¹. The net mixing specific energy expended in the process of the invention is usually greater than 0.20 kilowatt hours per kilogram of product produced; with 0.30 kilowatt hours per kilogram to 0.40 kilowatt hours per kilogram being typical.

In some embodiments, when applying a shear force includes exposing the starting polymer composition to a mixer, the mixer may be selected for its capability of generating a shear rate. For example, in some embodiments, a mixer capable of generating a shear rate of at least 500 sec⁻¹ is suitable. Generally, generating this shear rate requires a high speed internal mixer having a narrow clearance between the tips of the pulverizing elements and the wall. Shear rate is determined by the velocity gradient in the space between the tip of the element and the wall of the barrel section. Depending upon the clearance between the tip and the wall, rotation of the pulverizing elements from 100 to 500 revolutions per minute (rpm) is generally adequate to develop a sufficient shear rate. Depending upon the number of tips on a given pulverizing element and the rate of rotation, the number of times the composition is pulverized by each element is at least 1 time per second, preferably at least 5 times per second, and more preferably at least 10 times per second. The composition may be pulverized by each element up to 30 times per second. This means that material typically is pulverized from 500 to 5000 times during processing. For example, in a bilobe pulverizing element rotating at 200 rpm wherein the residence time for material at that element is 3 seconds, the material will be pulverized 20 times by said element.

In some embodiments, applying a shear force includes exposing the starting polymer composition to a mixer, the mixer may be selected for its capability of generating a specific energy. For example, in some embodiments, a mixer capable of generating a specific energy of at least 0.2 kw*hr/kg is suitable.

In some embodiments applying shear force may include using a 150 horse power (hp) intermeshing, co-rotating twin-screw extruder made by Werner and Pfleiderer (ZSK-70). This twin-screw extruder, also known as a pulverizer in this process, has an element diameter (D) of 70 mm throughout its entire length and a shaft length to diameter ratio (L/D) of 16. In some embodiments, the screws are modular in nature and are designed to include a combination of spiral conveying and bilobe pulverization elements.

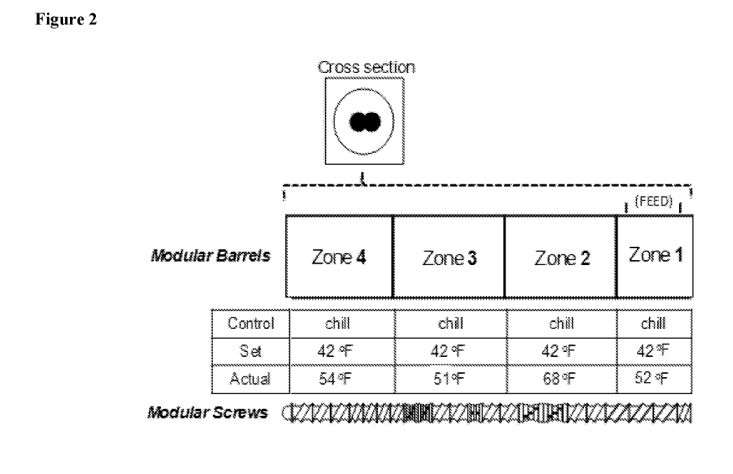

A pulverizer may be configured to include one or more pulverization zones and one or more conveying zones, as shown in one embodiment in FIG. 2. In some embodiments, a pulverizer is configured to include a pulverization zone that includes several pulverization elements. A conveying zone may follow a pulverization zone to cool the deformed material before additional pulverization. A pulverization element may include a neutral pulverization element and/or a reverse pulverization element. A reverse pulverization element and, to a lesser extent, a neutral pulverization element retain the material in the pulverization zone, thereby controlling the amount of shear energy being applied. The harshness of a screw design relates to the number of pulverization elements fitted onto an extruder's shaft and to the type of pulverization element (neutral or reverse). (Brunner et al., Polymer Engineering and Science 2012, 52(7):1555-1564.) In some embodiments, the apparatus, components, and operation of the pulverizer are as described in U.S. Pat. Nos. 5,814,673; 6,180,685; 6,818,173; and 7,223,359. In some embodiments, it is preferable to use a screw configuration including more than three neutral and reverse pulverization elements.

In some embodiments, the starting polymer composition may be fed into the pulverization apparatus at room temperature. In some embodiments, the starting polymer composition may be fed into the pulverization apparatus at 25° C. In some embodiments, the starting polymer composition may be fed into the pulverization apparatus using a Schenk volumetric feeder.

In some embodiments, one or more portions of the barrels and shafts of the pulverizer are cooled during the pulverization process. Such cooling may be accomplished through the use of one or more of a heat exchange coil, a compressor, a refrigerator, and a solid state cooling device through a temperature control system. For example, the cooling may occur by recirculating a coolant. In an illustrative embodiment, the coolant may be a propylene glycol/water (40/60 volume/volume (vol/vol)) mixture. In many embodiments, the coolant may be maintained at a temperature in a range of −20° C. to 50° C. (−4° F. to 122° F.). In an illustrative embodiment, the coolant may be maintained at a temperature in a range of −5° C. to 35° C. (23° F. to 95° F.). In many embodiments, the flow rate of coolant through the pulverization apparatus may be set at 10 gallons per minute (gpm) (37.9 Liters per minute (Lpm)) to 70 gpm (265 Lpm). In an illustrative embodiment, the flow rate of coolant through the pulverization apparatus may be set at 20 gpm (75.7 Lpm) to 30 gpm (114 Lpm).

The screw rotation speed of the pulverizer may be varied or maintained at a constant speed. In some embodiments, the screw rotation speed may be maintained in a range of 50 rpm to 1200 rpm. For example, in an illustrative embodiment, the screw rotation speed may be maintained at a constant 200 rpm, imparting a load on the 150 hp motor of 30% to 35%. In some embodiments, a material including the starting polymer composition may pass through the pulverizer at a rate in a range of 1 kg/hour to 400 kg/hour. In an illustrative embodiment, the material may pass through the pulverizer at a rate of 75 kg/hour. In some embodiments, 15 kilo-British thermal units per hour (kBTU/hr) to 200 kBTU/hr may be removed from the pulverizer during steady state processing. In an illustrative embodiment, 120 kBTU/hr to 140 kBTU/hr may be removed from the pulverizer during steady state processing.

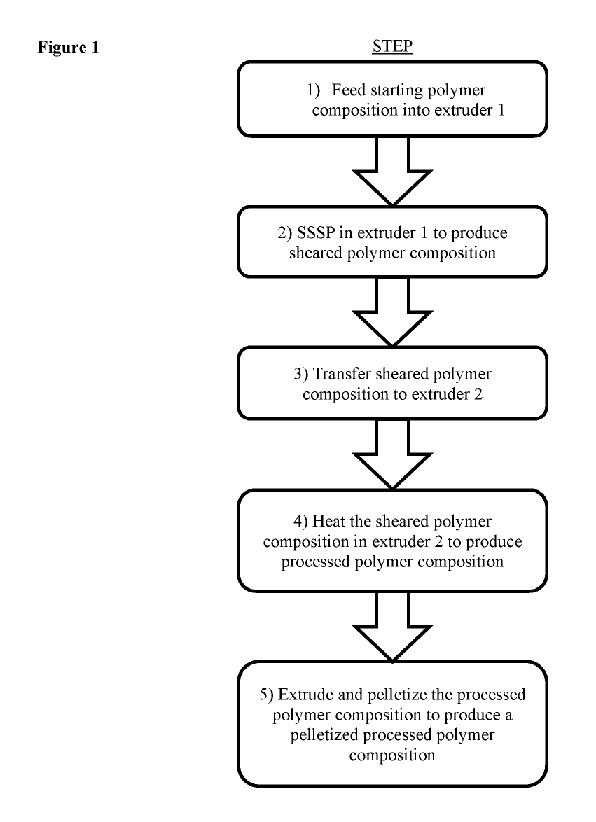

In some embodiments, applying a shear force includes solid-state shear pulverization (SSSP) and/or solid-state/melt extrusion (SSME), described, for example, in U.S. Pat. No. 9,186,835. As shown, in one embodiment, in FIG. 1, applying a shear force may include feeding an ultra-high molecular weight polymer into a first extruder and using the first extruder to perform SSSP.

In some embodiments, the sheared polymer composition preferably has a lower weight average molecular weight (M_{w}) than the starting polymer composition. For example, the M_{w} of the sheared polymer composition may be at least 10%, at least 20%, at least 30%, at least 40%, at least 50%, at least 60%, at least 70%, at least 80%, or at least 90% lower than the M_{w} of the starting polymer composition.

In some embodiments, the sheared polymer composition has a weight average molecular weight (M_{w}) of at least 3×10⁵ g/mol, at least 4×10⁵ g/mol, at least 5×10⁵ g/mol, at least 6×10⁵ g/mol, at least 7×10⁵ g/mol, or at least 8×10⁵ g/mol.

In some embodiments, the sheared polymer composition may have a higher number average molecular weight (Mₙ) than the starting polymer composition. For example, the Mₙ of the sheared polymer composition may be at least 1%, at least 5%, at least 10%, at least 20%, or at least 30% higher than the Mₙ of the starting polymer composition.

In some embodiments, the sheared polymer composition preferably has a lower polydispersity index (PDI) than the PDI of the starting polymer composition. For example, the PDI of the sheared polymer composition may be at least 10%, at least 20%, at least 30%, at least 40%, at least 50%, at least 60%, or at least 70% lower than the PDI of the starting polymer composition.

In some embodiments, the sheared polymer composition may have a polydispersity index (PDI) of less than 5, less than 4, less than 3.5, less than 3, less than 2.5, or less than 2.

In some embodiments, the sheared polymer composition may have a static coefficient of friction of less than 0.3, less than 0.25, or less than 0.2, wherein the static coefficient of friction is measured according to ASTM D-1894-14. In some embodiments, the sheared polymer composition may have a dynamic coefficient of friction of less than 0.3, less than 0.25, or less than 0.2, wherein the dynamic coefficient of friction is measured according to ASTM D-1894-14.

Without wishing to be bound by theory, it is believed that the applying a shear force to a polymer to form a sheared polymer, as described herein, selectively cleaves very large polymer chains but leaves shorter chains intact. In addition, free radicals generated during the process may react with shorter length polymer chains and thereby raise the number average molecular weight (Mₙ) of the sheared polymer. Thus, the process lowers the weight average molecular weight (M_{w}) and raises the number average molecular weight (Mₙ), improving processability of the sheared polymer composition while the maintaining or improving at least one of tensile strength, impact resistance, wear/abrasion resistance, and toughness of the polymer composition. In some embodiments, the sheared polymer composition may be melt processable. In some embodiments, the sheared polymer composition may be injection moldable.

Illustrative examples of compositions including a sheared polymer are shown in Examples 53 and 54.

In some embodiments, the method has two steps. In some embodiments, the second step includes treating the sheared polymer composition to form a processed polymer composition. Treating the sheared polymer composition to form a processed polymer composition may include heating the sheared polymer composition or applying shear force to the sheared polymer composition or both. In some embodiments, heating the sheared polymer composition and applying shear force to the sheared polymer composition are performed simultaneously. In some embodiments, it is preferred to perform the steps of the method sequentially. In some embodiments, the first step (forming a sheared polymer) and the second step (forming a processed polymer) may take place in separate zones of a single piece of equipment. The method may be performed in a single machine, two separate machines, or three or more separate machines.

Without wishing to be bound by theory, it is believed that treating the sheared polymer composition to form a processed polymer composition decreases both M_{w} and Mₙ, allowing the processed polymer composition to be used for injection molding using standard molding equipment and conditions.

In some embodiments, the method includes conveying the sheared polymer composition to a device that may heat the sheared polymer composition. As shown, in one embodiment, in FIG. 1, the method may include transferring the sheared polymer composition to a second extruder. In some embodiments, the sheared polymer composition may be conveyed by a volumetric feeder. In some embodiments, the sheared polymer composition may be heated in the same device that applied a specific energy of at least 0.2 kw*hr/kg.

In some embodiments, treating the sheared polymer composition to form the processed polymer composition includes treating the sheared polymer composition so that it achieves a melt flow index of at least 0.01, at least 0.03, at least 0.05, at least 0.07, at least 0.1, at least 0.2, at least 0.4, at least 0.9, at least 1, at least 1.5, at least 1.7, or at least 2. In some embodiments the processed polymer composition has a melt flow index of up to 0.5, up to 1, up to 2, up to 2.5, up to 3, up to 5, up to 10, up to 15, up to 30, up to 50, or up to 100. In some embodiments, it is preferred that the melt flow index of the processed polymer composition is at least 0.01. In some embodiments, for example, when the starting polymer composition includes at least 99 wt % of a polymer having a molecular weight of at least 1×10⁶ g/mol, the processed polymer composition may have a melt flow index in a range of 0.01 to 5.

In some embodiments, treating the sheared polymer composition to form the processed polymer composition includes heating the sheared polymer composition to a temperature at least 100° C., at least 110° C., at least 120° C., at least 130° C., at least 140° C., at least 150° C., at least 160° C., at least 170° C., at least 180° C., at least 210° C., or at least 230° C. greater than the melting point of the starting polymer composition.

In some embodiments, treating the sheared polymer composition to form the processed polymer composition includes heating the sheared polymer composition up to 20° C., up to 30° C., up to 40° C., up to 50° C., up to 55° C., up to 60° C., up to 65° C., up to 70° C., or up to 75° C. less than the degradation temperature of the starting polymer composition. In some embodiments, it is preferred to heat the sheared polymer composition to a temperature 50° C. less than the degradation temperature of the starting polymer composition.

In some embodiments, treating the sheared polymer composition to form the processed polymer composition includes heating the sheared polymer composition to a temperature of up to 250° C., up to 300° C., up to 400° C., up to 430° C., up to 440° C., up to 450° C., up to 500° C., or up to 550° C.

In some embodiments, treating the sheared polymer composition to form the processed polymer composition preferably includes applying shear force to the sheared polymer composition. The shear force may be applied while heating the sheared polymer composition. In some embodiments, applying a shear force includes exposing the sheared polymer composition to a mixer, as further described above. In some embodiments, treating the sheared polymer composition to form a processed polymer composition includes solid-state shear pulverization (SSSP) and/or solid-state/melt extrusion (SSME).

In some embodiments, treating the sheared polymer composition to form the processed polymer composition includes treating the sheared polymer composition such that the weight average molecular weight (M_{w}) of the sheared polymer composition is decreased by at least 20%, at least 30%, at least 40%, at least 50%, at least 60%, at least 70%, at least 80%, or at least 90%. In some embodiments, the processed polymer composition has a weight average molecular weight of at least 20%, at least 30%, at least 40%, at least 50%, at least 60%, at least 70%, at least 80%, or at least 90% less than the weight average molecular weight of the sheared polymer composition.

In some embodiments, the processed polymer composition has a weight average molecular weight (M_{w}) of at least 30% less, at least 40% less, at least 50% less, at least 60% less, at least 70% less, at least 80% less, or at least 90% less than a weight average molecular weight (M_{w}) of the starting polymer composition.

In some embodiments, the processed polymer composition may have a static coefficient of friction of less than 0.3, less than 0.25, or less than 0.2, wherein the static coefficient of friction is measured according to ASTM D-1894-14. In some embodiments, the processed polymer composition may have a dynamic coefficient of friction of less than 0.3, less than 0.25, or less than 0.2, wherein the dynamic coefficient of friction is measured according to ASTM D-1894-14.

In some embodiments, treating the sheared polymer composition to form the processed polymer composition includes decreasing the polydispersity index (PDI) of the composition. For example, treating the sheared polymer composition may include decreasing the polydispersity index (PDI) by at least 10%, at least 20%, at least 30%, at least 40%, at least 50%, or at least 60%. In some embodiments, the processed polymer composition has a PDI at least 10%, at least 20%, at least 30%, at least 40%, at least 50%, or at least 60% lower than the PDI of the sheared polymer composition. In some embodiments, the processed polymer composition has a PDI of at least 30%, at least 40%, at least 50%, at least 60%, at least 70%, at least 80%, or at least 90% lower than the PDI of the starting polymer composition.

In some embodiments, treating the sheared polymer composition to form the processed polymer composition preferably changes the z average molecular weight (M_{z}) of the sheared polymer composition by up to 5%, up to 10%, up to 20%, up to 25%, up to 30%, up to 35%, or up to 40%. In some embodiments, treating the sheared polymer composition to form the processed polymer composition does not change the z average molecular weight (M_{z}) of the sheared polymer more than 10%, more than 20%, more than 25%, more than 30%, more than 35%, or more than 40% during heating the sheared polymer. In some embodiments, the processed polymer composition has a z average molecular weight (M_{z}) of no more than 10%, no more than 20%, no more than 25%, no more than 30%, no more than 35%, or no more than 40% of the z average molecular weight (M_{z}) of the sheared polymer.

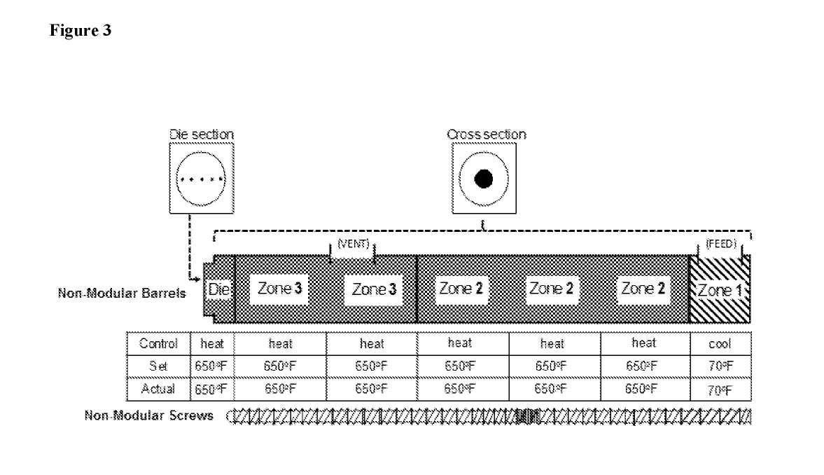

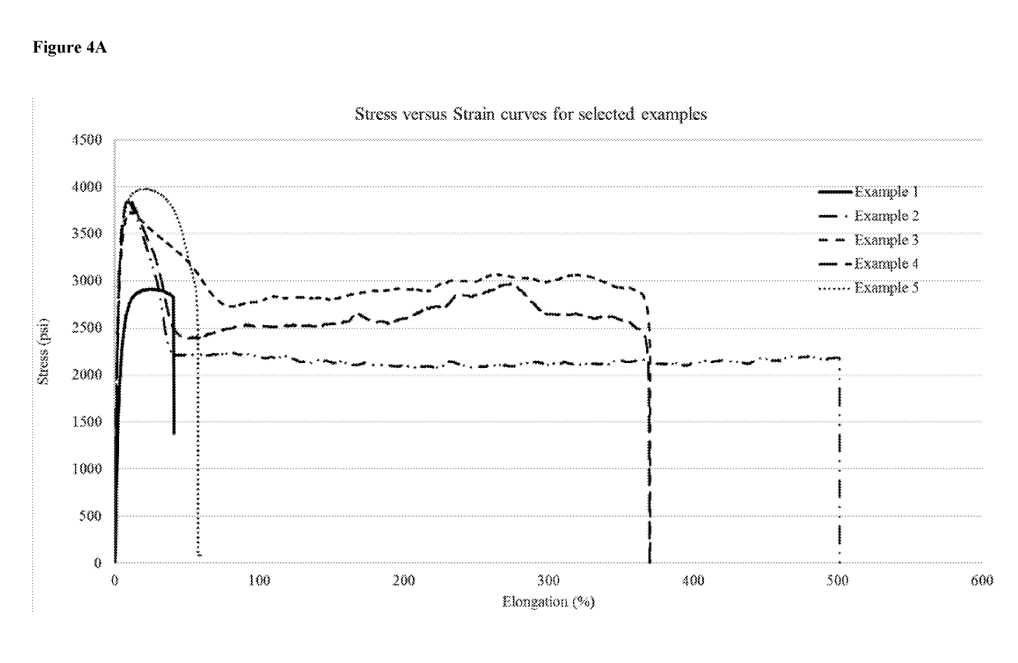

As shown, for example, in FIG. 3, in some embodiments, the second extruder may have different zones set to different temperatures.

In some embodiments, treating the sheared polymer composition to form the processed polymer composition includes heating the sheared polymer composition to a temperature of at least 260° C. (500° F.), at least 288° C. (550° F.), at least 316° C. (600° F.), and/or up to 343° C. (650° F.), up to 357° C. (675° F.), or up to 371° C. (700° F.). In some embodiments when the starting polymer composition includes at least 99 wt % of a polyethylene having a molecular weight of at least 1×10⁶ g/mol, forming the processed polymer composition includes heating the sheared polymer composition to a temperature of at least 260° C. (500° F.), at least 288° C. (550° F.), at least 316° C. (600° F.), and/or up to 343° C. (650° F.), up to 357° C. (675° F.), or up to 371° C. (700° F.). In some embodiments, forming the processed polymer composition includes heating the sheared polymer composition to a temperature in a range of 260° C. (500° F.) to 343° C. (650° F.). In some embodiments, forming the processed polymer composition includes heating the sheared polymer to a temperature of at least 338° C. (640° F.).

In some embodiments, treating the sheared polymer composition to form the processed polymer composition includes heating the sheared polymer composition so that the sheared polymer composition forms a continuum melt when heated to a temperature greater than its melting point.

In some embodiments, treating the sheared polymer to form the processed polymer composition includes treating the sheared polymer composition so that that the processed polymer composition has a toughness of at least 90,000 psi, at least 100,000 psi, at least 110,000 psi, at least 115,000 psi, at least 125,000 psi, or at least 150,000 psi. In some embodiments, the processed polymer composition has a toughness of up to 150,000 psi, up to 175,000 psi, up to 200,000 psi, up to 225,000 psi, up to 250,000 psi, up to 275,000 psi, or up to 300,000 psi. For example, the processed polymer composition may have a toughness in a range of 115,000 psi to 250,000 psi. The comparative toughness, as described herein, is the area under a stress-strain curve measured from 0% to 40% elongation, using Type 1 tensile specimens of the processed polymer composition conditioned for at least 40 hours at 23° C. and 50% relative humidity (procedure A) and pulled at 2 inches/minute (50.8 mm/min) according to ASTM D-638-14.

In some embodiments, a processed polymer composition has an increased toughness compared to the starting polymer composition (including unprocessed polymer having molecular weight of at least 7.5×10⁵ g/mol). In some embodiments, a processed polymer composition that has increased toughness is preferably injection moldable. In some embodiments a processed polymer composition has an increased toughness compared to the starting polymer composition (including unprocessed polymer having molecular weight of at least 7.5×10⁵ g/mol). A processed polymer composition that has increased toughness may be produced by, for example, decreasing the shear rate or residence time of the first step, adding unprocessed ultra-high molecular weight polymer during or after the second step, increasing the speed of the second step, and/or using a lower temperature for the second step. For example, for UHMWPE, using a temperature in a range of 260° C. (500° F.) to 343° C. (650° F.) during the second step may, in some processing conditions, produce a processed polymer composition having increased toughness.

In some embodiments, the sheared polymer composition may be heated by a melt extruder including, for example, a single-screw melt extruder. One embodiment of a suitable melt extruder is shown in FIG. 3. In some embodiments, the extruder may be a 50 hp, 63.5 mm Welex Model 250 single-screw melt extruder having an L/D of 32/1. In some embodiments, temperatures of the barrel, die adaptor, and die head of the melt extruder may be maintained at 300° C. to 380° C. (572° F. to 716° F.). In an illustrative embodiment, temperatures of the barrel, die adaptor, and die head of the melt extruder may be maintained at 335° C. to 360° C. (635° F. to 680° F.). In some embodiments, the throughput of the melt extruder may be 15 kg/hour to 1000 kg/hour. In an illustrative embodiment, the throughput of the melt extruder may be 75 kg/hour. In some embodiments, the load on a 50 hp motor may be 1% to 99%. In an illustrative embodiment, the load on the 50 hp motor may be 25%. In some embodiments, the die pressure may be kept at 1 MPa to 1000 MPa. In an illustrative embodiment, the die pressure may be kept to a value less than 20 MPa. In some embodiments, the temperature of one or more portions of the area around the barrels and within the screw shaft may be cooled during the heating process. Such cooling may be accomplished through the use of one or more of a heat exchange coil, a compressor, a refrigerator, and a solid state cooling device through a temperature control system. For example, the cooling may occur by recirculating a coolant. In an illustrative embodiment, room temperature water may be used as a coolant. In some embodiments, the output of the melt-extruded material may be passed through a water trough. The water in the water trough may be held at a temperature of 1° C. to 100° C. (34° F. to 212° F.). In an illustrative embodiment, the output of the melt-extruded material may be passed through a water trough held at 20° C. to 50° C. (68° F. to 122° F.).

In some embodiments, the sheared polymer composition and/or the processed polymer composition may include an additive. An additive (which also may be referred to as an adjuvant) may include, for example, a filler (an organic filler and/or an inorganic filler), a thermal and/or a UV stabilizer, an antioxidant, a dye, a pigment, a colorant, an oil, or a lubricant, or a combination thereof.

In some embodiments, the method further includes a processing step. The processing step may include, for example, melt processing the processed polymer composition; extruding the processed polymer composition; forming a powder that includes the sheared polymer composition or the processed polymer composition; forming a solvent solution that includes the sheared polymer composition or the processed polymer composition; and/or forming pellets of the sheared polymer composition or from the processed polymer composition. As shown, in one embodiment, in FIG. 1, a processing step may include pelletizing the processed polymer composition. The sheared polymer composition or processed polymer composition may be formed into a powder or pelletized according to conventional methods. In some embodiments, a rotary pelletizer may be used. In some embodiments, an underwater pelletizer may be used.

In some embodiments, the method further includes cooling the processed polymer composition. The processed polymer composition may be cooled to room temperature, for example. In some embodiments, the processed polymer composition may be cooled to a temperature of up to 25° C., up to 23° C., or up to 21° C. In some embodiments, the method includes conditioning the processed polymer composition at a specific temperature and humidity. For example, the processed polymer composition may be cooled to 23° C. and conditioned for at least 10 hours, at least 20 hours, at least 30 hours, or at least 40 hours and/or up to 20 hours, up to 30 hours, up to 40 hours, or up to 50 hours. The polymer composition may be conditioned at 23° C. and up to 40% humidity, up to 45% humidity, up to 50% humidity, or up to 55% humidity.

### Composition

The present disclosure further provides a composition including a sheared polymer or a processed polymer. In some embodiments, the composition is melt processable. In some embodiments, the composition is injection moldable.

In some embodiments, a composition including a sheared polymer preferably has a contraction factor (g′) in a range of 0.999 to 0.850 for polymers having molecular weights (MW) in a range of 1×10⁴ g/mol to 1×10⁸ g/mol. In some embodiments, the composition including a sheared polymer also has a weight average molecular weight (M_{w}) of at least 5×10⁵ g/mol and/or a polydispersity index (PDI) of up to 4, up to 5, or up to 6. In some embodiments, the composition including a sheared polymer results from the methods described herein.

In some embodiments, a composition including a processed polymer preferably has a complex viscosity in a range of 1×10⁴ Pa·s to 1×10⁸Pa·s at 1×10⁻² rad/s. In some embodiments, the composition has a weight average molecular weight (M_{w}) of at least 5×10⁴ g/mol and/or a PDI of up to 4. In some embodiments, the composition including a processed polymer results from the methods described herein.

In some embodiments, the composition has a PDI of up to 2.5, up to 3, up to 3.5, up to 4, up to 5, or up to 6. In some embodiments, including, for example, when the composition includes a processed polymer, the PDI is preferably up to 4. In some embodiments, the composition has a PDI of less than 4, less than 3.5, less than 3, less than 2.5.

In some embodiments, the composition may have a contraction factor (g′) of at least 0.800, at least 0.825, at least 0.850, or at least 0.875, and up to 0.999 for polymers having a molecular weight (MW) in a range of 1×10⁴ g/mol to 1×10⁸ g/mol. In some embodiments, the contraction factor (g′) is preferably in a range of 0.999 to 0.850 for polymers having a molecular weight in a range of 1×10⁴ g/mol to 1×10⁸ g/mol. Without being limited by theory, a flat g′ curve typically indicates that significant branching is not occurring across a broad molecular weight distribution, which leads to increased crystallinity and improved physical properties of the polymer composition. At the time of the invention, it was not known how to obtain these contraction factor ranges using standard synthesis known in the art (See Gabriel et al., 2002 Polymer 43(24):6383-6390.)

The composition may include any suitable polymer or combination of polymers having a weight average molecular weight of at least 5×10⁵ g/mol. In some embodiments, the polymer has a weight average molecular weight of at least 7.5×10⁵ g/mol, at least 1×10⁶ g/mol, at least 1.5×10⁶ g/mol, at least 2×10⁶ g/mol, at least 4×10⁶ g/mol, at least 5×10⁶ g/mol, or at least 8×10⁶ g/mol. In some embodiments, the polymer has a weight average molecular weight of up to 1×10⁶ g/mol, up to 1.5×10⁶ g/mol, up to 2×10⁶ g/mol, up to 2.5×10⁶ g/mol, up to 3×10⁶ g/mol, up to 3.5×10⁶ g/mol, up to 4×10⁶ g/mol, up to 5×10⁶ g/mol, up to 6×10⁶ g/mol, up to 7×10⁶ g/mol, up to 8×10⁶ g/mol, up to 9×10⁶ g/mol, or up to 10×10⁶ g/mol. The composition may include, for example, a polyethylene having a weight average molecular weight of at least 5×10⁵ g/mol, a polytetrafluoroethylene having a weight average molecular weight of at least 5×10⁵ g/mol, a polypropylene having a weight average molecular weight of at least 5×10⁵ g/mol, a polystyrene having a weight average molecular weight of at least 5×10⁵ g/mol, a polyvinylchloride having a weight average molecular weight of at least 5×10⁵ g/mol, or a polyester having a weight average molecular weight of at least 5×10⁵ g/mol, or a combination thereof (for example, mixtures and copolymers thereof).

In some embodiments, the polymer preferably includes a polyolefin. In some embodiments, the polymer preferably includes a polyolefin having a molecular weight of at least 5×10⁵ g/mol. In some embodiments, the polymer preferably includes a polyethylene. In some embodiments, the polymer preferably includes a polyethylene having a molecular weight of at least 5×10⁵ g/mol.

In some embodiments, the polymer preferably includes a polyethylene having a weight average molecular weight (M_{w}) of at least 5×10⁵ g/mol, at least 7×10⁵ g/mol, at least 1×10⁶ g/mol, at least 1.5×10⁶ g/mol, or at least 2×10⁶ g/mol.

In some embodiments, the composition may include a solvent. The composition preferably includes less than 100 parts per million (ppm) of a solvent, less than 50 ppm of a solvent, less than 25 ppm of a solvent, less than 10 ppm of a solvent, or less than 1 ppm of a solvent. In some embodiments, the solvent includes a gel solvent. In some embodiments, the composition includes less than 100 ppm of a gel solvent residue, less than 50 ppm of a gel solvent residue, less than 25 ppm of a gel solvent residue, less than 10 ppm of a gel solvent residue, or less than 1 ppm of a gel solvent residue. A solvent and/or a gel solvent may include, for example, decalin, paraffin oil, or vegetable oil. In some embodiments, the composition preferably does not include a sufficient quantity of solvent to alter the melt flow index of the composition.

In some embodiments, the composition has a storage modulus plateau at 150° C. of at least 1 megapascal (MPa), at least 1.25 MPa, or at least 1.5 MPa. The storage modulus plateau of a composition is typically influenced by molecular entanglements. A higher storage modulus plateau indicates a stiffer material with improved mechanical properties, such as one or more of tensile, impact, or compression strength, or increased toughness.

In some embodiments, the composition may have a z average molecular weight (M_{z}) of at least 1×10⁶ g/mol, at least 2×10⁶ g/mol, at least 3×10⁶ g/mol, at least 4×10⁶ g/mol, at least 5×10⁶ g/mol, or at least 6×10⁶ g/mol. In some embodiments, the composition may have a z average molecular weight (M_{z}) of up to 5×10⁶ g/mol, up to 6×10⁶ g/mol, up to 7×10⁶ g/mol, or up to 7.5×10⁶ g/mol.

In some embodiments, the composition may have a weight average molecular weight (M_{w}) of at least 4×10⁴ g/mol, at least 1×10⁵ g/mol, at least 2×10⁵ g/mol, at least 3×10⁵ g/mol, at least 4×10⁵ g/mol, at least 5×10⁵ g/mol, at least 7.5×10⁵ g/mol, at least 1×10⁶ g/mol, at least 1.5×10⁶ g/mol, at least 2×10⁶ g/mol, at least 2.5×10⁶ g/mol, or at least 3×10⁶ g/mol. In some embodiments, the composition may have a weight average molecular weight (M_{w}) of up to 1×10⁵ g/mol, up to 2×10⁵ g/mol, up to 3×10⁵ g/mol, up to 4×10⁵ g/mol, up to 5×10⁵ g/mol, up to 1×10⁶ g/mol, up to 1.5×10⁶ g/mol, up to 2×10⁶ g/mol, up to 2.5×10⁶ g/mol, up to 3×10⁶ g/mol, or up to 3.5×10⁶ g/mol.

In some embodiments, including for example, when the composition includes a sheared polymer, the composition preferably has a weight average molecular weight (M_{w}) of up to 1×10⁶ g/mol, up to 1.5×10⁶ g/mol, up to 2×10⁶ g/mol, up to 2.5×10⁶ g/mol, up to 3×10⁶ g/mol, or up to 3.5×10⁶ g/mol.

In some embodiments, including for example, when the composition includes a processed polymer, the composition preferably has a weight average molecular weight (M_{w}) of up to 1×10⁵ g/mol, up to 2×10⁵ g/mol, up to 3×10⁵ g/mol, up to 4×10⁵ g/mol, or up to 5×10⁵ g/mol.

In some embodiments, the composition has a complex viscosity of at least 1×10⁴Pa·s, at least 1×10⁵ Pa·s, at least 1×10⁶ Pa·s, at least 1×10⁷ Pa·s, or at least 1×10⁸ Pa·s at 1×10⁻² rad/s. In some embodiments, the composition has a complex viscosity of up to 1×10⁵Pa·s, up to 1×10⁶P·s, up to 1×10⁷Pa·s, up to 1×10⁸ Pa·s, or up to 1×10⁹ Pa·s at 1×10⁻² rad/s. In some embodiments, the complex viscosity of the composition is preferably in a range of 1×10⁴Pa·s to 1×10⁸ Pa·s at 1×10⁻² rad/s.

In some embodiments, including for example, when the composition includes a processed polymer, the composition has a melt flow index of at least 0.01, at least 0.03, at least 0.05, at least 0.07, at least 0.1, at least 0.2, at least 0.4, at least 0.9, at least 1, at least 1.5, at least 1.7, or at least 2. In some embodiments the processed polymer has a melt flow index of up to 0.5, up to 0.6, up to 0.8, up to 1, up to 2, up to 2.5, up to 3, up to 5, up to 10, or up to 15. In some embodiments, the composition may have a melt flow index in a range of 0.01 to 5.

In some embodiments, the composition may have a toughness of at least 90,000 psi, at least 100,000 psi, at least 110,000 psi, at least 115,000 psi, at least 125,000 psi, or at least 150,000 psi. In some embodiments, the composition has a toughness of up to 150,000 psi, up to 175,000 psi, up to 200,000 psi, up to 225,000 psi, up to 250,000 psi, up to 275,000 psi, or up to 300,000 psi. For example, the composition may have a toughness in a range of 115,000 psi to 250,000 psi. The toughness is the area under a stress-strain curve measured from 0% to 40% elongation, using Type 1 tensile specimens of the processed polymer conditioned for at least 40 hours at 23° C. and 50% relative humidity (procedure A) and pulled at 2 inches/minute (50.8 mm/min) according to ASTM D-638-14.

In some embodiments, the composition does not exhibit break from a notched IZOD test (ASTM D-256). In some embodiments, the composition does not exhibit break from a 5 foot-pound per square inch (fl-lb/in²) double notched IZOD test (ASTM D-4050).

In some embodiments, the composition may include an additive. An additive (which also may be referred to as an adjuvant) may include, for example, a filler (an organic filler and/or an inorganic filler), a thermal and/or a UV stabilizer, an antioxidant, a dye, a pigment, a colorant, an oil, or a lubricant, or a combination thereof. In some embodiments it is preferred that the additive is included in the composition in a sufficient amount to increase the melt flow index of the composition to at least 0.01. In some embodiments, a composition that includes a polymer and an additive may have the same melt flow index as a composition that includes only a polymer having a molecular weight of at least 1×10⁶ g/mol.

Optionally, any suitable thermal and/or a UV stabilizer may be included in the composition including, for example, one or more of the following: 4-Allyloxy-2-hydroxybenzophenone; 1-Aza-3,7-dioxabicyclo[3.3.0]octane-5-methanol; 2-(2H-Benzotriazol-2-yl)-4,6-bis(1-methyl-1-phenylethyl)phenol; 2-(2H-Benzotriazol-2-yl)-4,6-di-tert-pentylphenol; 2-(2H-Benzotriazol-2-yl)-6-dodecyl-4-methylphenol; 2-[3-(2H-Benzotriazol-2-yl)-4-hydroxyphenyl]ethyl methacrylate; 2-(2H-Benzotriazol-2-yl)-4-methyl-6-(2-propenyl)phenol; 2-(2H-Benzotriazol-2-yl)-4-(1,1,3,3-tetramethylbutyl)phenol; 2-(4-Benzoyl-3-hydroxyphenoxy)ethyl acrylate; 3,9-Bis(2,4-dicumylphenoxy)-2,4,8,10-tetraoxa-3,9-diphosphaspiro[5.5]undecane; Bis(octadecyl)hydroxylamine; 3,9-Bis(octadecyloxy)-2,4,8,10-tetraoxa-3,9-diphosphaspiro[5.5]undecane; Bis(1-octyloxy-2,2,6,6-tetramethyl-4-piperidyl) sebacate; Bis(2,2,6,6-tetramethyl-4-piperidyl) sebacate; 2-tert-Butyl-6-(5-chloro-2H-benzotriazol-2-yl)-4-methylphenol; 2-tert-Butyl-4-ethylphenol; 5-Chloro-2-hydroxybenzophenone; 5-Chloro-2-hydroxy-4-methylbenzophenone; 2,4-Di-tert-butyl-6-(5-chloro-2H-benzotriazol-2-yl)phenol; 2,6-Di-tert-butyl-4-(dimethylaminomethyl)phenol; 3′,5′-Dichloro-2′-hydroxyacetophenone; Didodecyl 3,3′-thiodipropionate; 2,4-Dihydroxybenzophenone; 2,2′-Dihydroxy-4,4′-dimethoxybenzophenone; 2,2′-Dihydroxy-4-methoxybenzophenone; 2′,4′-Dihydroxy-3′-propylacetophenone; 2,3-Dimethylhydroquinone; 2-(4,6-Diphenyl-1,3,5-triazin-2-yl)-5-[(hexyl)oxy]-phenol; 5-Ethyl-1-aza-3,7-dioxabicyclo[3.3.0]octane; Ethyl 2-cyano-3,3-diphenylacrylate; 2-Ethylhexyl 2-cyano-3,3-diphenylacrylate; 2-Ethylhexyl trans-4-methoxycinnamate; 2-Ethylhexyl salicylate; 2,2′-Ethylidene-bis(4,6-di-tert-butylphenol); 2-Hydroxy-4-(octyloxy)benzophenone; Menthyl anthranilate; 2-Methoxyhydroquinone; Methyl-p-benzoquinone; 2,2′-Methylenebis[6-(2H-benzotriazol-2-yl)-4-(1,1,3,3-tetramethylbutyl)phenol]; 2,2′-Methylenebis(6-tert-butyl-4-ethylphenol); 2,2′-Methylenebis(6-tert-butyl-4-methylphenol); 5,5′-Methylenebis(2-hydroxy-4-methoxybenzophenone); Methylhydroquinone; 4-Nitrophenol sodium salt hydrate; Octadecyl 3-(3,5-di-tert-butyl-4-hydroxyphenyl)propionate; Pentaerythritol tetrakis(3,5-di-tert-butyl-4-hydroxyhydrocinnamate); 2-Phenyl-5-benzimidazolesulfonic acid; Poly[[6-[(1,1,3,3-tetramethylbutyl)amino]-s-triazine-2,4-diyl]-[(2,2,6,6-tetramethyl-4-piperidyl)imino]-hexamethylene-[(2,2,6,6 -tetramethyl-4-piperidyl)imino]; Sodium D-isoascorbate monohydrate; Tetrachloro-1,4-benzoquinone; Triisodecyl phosphite; 1,3,5-Trimethyl-2,4,6-tris(3,5-di-tert-butyl-4-hydroxybenzyl)benzene; Tris(4-tert-butyl-3-hydroxy-2,6-dimethylbenzyl) isocyanurate; Tris(2,4-di-tert-butylphenyl) phosphite; Tris(2,4-di-tert-butylphenyl) phosphite; Tris(nonylphenyl) phosphite.butylphenyl) phosphite; Tris(nonylphenyl) phosphite.

In some embodiments, any suitable antioxidant may be included in the starting material or added during the process, including, for example, solid and liquid primary and secondary antioxidants such as those available from Adeka Palmarole under the name ADK STAB. In some embodiments, the antioxidant may be phenolic, phosphorus based, or sulfur based.

In some embodiments, any suitable colorant may be included in the composition, including, for example, any conventional inorganic and organic pigments, organic dyestuff, or carbon black. A colorant may be included, for example, in amounts of up to 1 wt %, up to 3 wt %, up to 5 wt %, or up to 10% of the composition, and/or in amounts useful to achieve desired color characteristic. Those skilled in the art also will be aware of suitable pigments, organic pigments, and dyestuffs useful as colorants. Such materials described, for example, in Kirk-Othmer Encyclopedia of Chemical Technology, Third Edition, Vol 6. Pages 597-617; examples include but are not limited to:
Inorganic types such as titanium dioxide, carbon black, iron oxide, zinc chromate, cadmium sulfides, chromium oxides, sodium aluminum silicate complexes, such as ultramarine pigments, metal flakes and the like; and
Organic pigments such as azo and diazo pigments, phthalocynanines, quinarcridone pigments, perylene pigments, isoindoline, anthraquinones, thioindigo, and the like. Other additives or mixtures thereof may also be included in the colorant polymer mixture such as, for example, lubricants, antistatic agents, impact modifiers, antimicrobials, light stabilizers, filler/reinforcing materials (for example, CaCO₃), heat stabilizers, release agents, rheological control agents such as clay, etc.
   The colorants and/or other additives may be incorporated in combinations and/or amounts known by those skilled in the art to achieve to desired effect.

In some embodiments, any suitable organic filler may be included in the composition including, for example, cellulose, rice husk ash, lignin, grape seeds, coconut fiber, any solid organic wastes, post-consumer refuse, agricultural and manufacturing by-products, and combinations thereof.

In some embodiments, any suitable inorganic filler may be included in the composition including, for example, talc, silica, copper, aluminum, brass, tin, glass fiber, a nitrate, a bromide based flame retardant, an antimicrobial agent, an oxygen scavenger, unmodified and/or modified clay, unmodified and/or modified graphite, graphene, single or multi-walled carbon nanotubes, or any combination of filler and/or nanofiller.

In some embodiments, the composition may be formed into an article including molded article, a fiber, a tape, a blown film, or an extruded tubing. In some embodiments, a drawn fiber or tape formed from the sheared polymer composition, exhibits at least 10% higher tenacity than a fiber or tape produced from an unprocessed composition of similar M_{w} or from the starting polymer composition. In some embodiments, a drawn fiber or tape produced from the processed polymer composition exhibits at least 10% higher tenacity than a fiber or tape produced from an unprocessed composition of similar M_{w} or from the starting polymer composition. Without being limited by theory, the difference in tenacity is believed to be the result of the lower polydispersity index (PDI) of the sheared polymer composition or the processed polymer composition and/or from the sheared polymer composition or the processed polymer composition having fewer low molecular weight molecules, which do not contribute as significantly to tenacity as higher molecular weight molecules.

In some embodiments, articles formed of the composition could be used for most or all applications that currently are covered by standard ultra-high molecular weight polyethylene. For example, applications are envisioned in the wire and cable industry, the printed-circuit board industry, the semi-conductor industry, the chemical processing industry, the automotive industry, the out-door products and coatings industry, the food industry, and the biomedical industry. In particular, the composition may be used to form at least parts of articles such as, for example, a wire (and/or wire coating), an optical fiber (and/or coating), a cable, a printed-circuit board, a semiconductor, an automotive part, an outdoor product, a food-industry product, a biomedical intermediate or product such as artificial implants, orthopedic implants, a composite material, a melt-spun mono-or multi-filament fiber, an oriented or un-oriented fiber, a hollow, porous or dense component; a woven or non-woven fabric, a filter, a membrane, a film, a multi-layer-and/or multicomponent film, a barrier film, a battery separator film for primary or secondary batteries (for example, lithium ion batteries), a container, a bag, a bottle, a rod, a liner, a vessel, a pipe, a pump, a valve, an O-ring, an expansion joint, a gasket, a heat exchanger, an inj ection-molded article, a sealable packaging, a profile, a heat-shrinkable film, a thermoplastically welded part, a blow molded part, a roto molded part, a ram extruded part, a screw extruded profile, and/or fine particles formed by precipitation of a solution of polyethylene.

In some embodiments, intermediate and end-user wear resistant products may be made from the composition. Examples of these products include, but are not limited to granulate, thermoplastic composites; melt-spun mono-and multi-filament fibers, oriented and not, hollow, porous and dense, single-and multi-component; fabrics, non-wovens, cloths, felts, filters, gas house filtration bags; sheets, membranes; films, thin and thick, dense and porous; fine particle additives for coatings, doctor blades, containers, bags, bottles, generally simple and complex parts, rods, tubes, profiles, ski soles, snow board soles, snow mobile runners, hose linings; linings and internal components for vessels, tanks, columns, pipes, fittings, pumps; pump housings, valves, valve seats, tubes and fittings for beverage dispensing systems; O-rings, seals, gaskets, gears, ball bearings, screws, nails, nuts, bolts, heat exchangers, hoses, expansion joints, shrinkable tubes; coatings, such as protective coatings, electrostatic coatings, cable and wire coatings, optical fiber coatings, and the like. It is also envisaged that articles are made that are particularly useful as sliding members, such as tape guides, parts of artificial implants and the like. The above products and articles may be comprised in part or in total of the composition according to the present disclosure. Optionally, a product or article could further include dissimilar materials, such as, for example, in multilayer and multi-component films, coatings, injection molded articles, containers, pipes, profiles, sliding parts in printing devices; sliding parts in major appliances such as dish washers, cloth washers, dryers, etc.; sliding parts in automotive devices such as steering systems, steel cable guides; sliding parts in conveyor systems, sliding parts in elevators and escalators, and the like.

### Methods of Using

The present invention further provides methods of using the sheared polymer composition, as further described herein, and the processed polymer composition, as further described herein.

In some exemplary embodiments, the composition has a complex viscosity in a range of 1×10⁴ Pa·s to 1×10⁸ Pa·s at 1×10⁻² rad/s.

In some exemplary embodiments, the composition has a melt flow index of at least 0.01, at least 0.1, at least 0.5, at least 1, at least 1.5, at least 2, at least 2.5, or at least 3. In some embodiments, the composition has a melt flow index of up to 0.1, up to 0.5, up to 0.6, up to 0.7, up to 0.8, up to 0.9, up to 1, up to 1.5, up to 2, up to 2.5, up to 3, up to 4, or up to 5.

In some exemplary embodiments, the composition has a weight average molecular weight (M_{w}) of up to 1×10⁵ g/mol, up to 1.5×10⁵ g/mol, up to 2×10⁵ g/mol, up to 3×10⁵ g/mol, up to 4×10⁵ g/mol, or up to 5×10⁵ g/mol. In some exemplary embodiments, the composition may have a weight average molecular weight (M_{w}) of at least 4×10⁴ g/mol, at least 1×10⁵ g/mol, at least 2×10⁵ g/mol, at least 3×10⁵ g/mol, at least 4×10⁵ g/mol, at least 5×10⁵ g/mol, at least 7.5×10⁵ g/mol, at least 1×10⁶ g/mol, at least 1.5×10⁶ g/mol, at least 2×10⁶ g/mol, at least 2.5×10⁶ g/mol, or at least 3×10⁶ g/mol.

In some exemplary embodiments, the composition may have a z average molecular weight (M_{z}) of up to 5×10⁶ g/mol, up to 6×10⁶ g/mol, up to 7×10⁶ g/mol, or up to 7.5×10⁶ g/mol.

In some exemplary embodiments, the composition has a toughness of at least 115,000 psi, wherein the toughness is the area under a stress-strain curve measured from 0% to 40% elongation, using Type 1 tensile specimens of the processed polymer conditioned for at least 40 hours at 23° C. and 50% relative humidity (procedure A) and pulled at 2 inches/minute (50.8 mm/min) according to ASTM D-638-14.

In some exemplary embodiments, the PDI may preferably be up to 4.

In some exemplary embodiments, the contraction factor (g′) is preferably in a range of 0.999 to 0.850 for polymers having a molecular weight in a range of 1×10⁴ g/mol to 1×10⁸ g/mol.

In some exemplary embodiments, the composition has a storage modulus plateau at 150° C. of at least 1 megapascal (MPa), at least 1.25 MPa, or at least 1.5 MPa.

In some embodiments, the composition is melt processed using conventional melt processing methods to form products. In some embodiments, the composition is injection moldable.

Non-limiting examples of processing methods include extrusion (including, for example, profile extrusion), injection molding, blow molding, rotation molding, calendaring, compression molding, thermoforming, foaming, 3D printing, SLS printing, line extrusion, tube extrusion, melt spinning, fiber spinning, gel processing, and/or use as a melt strength additive for any of the aforementioned processing techniques. The melt processability of the sheared or processed polymer composition is not reliant on the use of a specific catalyst, nor mixing of the sheared or processed polymer with another polymer, additive, or gel solvent. In some embodiments, the composition does not include a gel solvent. In some embodiments, the composition preferably does not include a sufficient quantity of solvent to alter the melt flow index of the processed polymer composition. The present disclosure further provides methods of making melt processable polymer compositions, methods of using melt processable polymer compositions, and articles formed from melt processable polymers.

In some embodiments wherein the melt processing of the processed polymer includes injection molding, the injection molding may be operated at 100 psi to 25,000 psi and at temperatures in a range of 150° C. to 380° C. (302° F. to 716° F.).

In some embodiments wherein the melt processing of the processed polymer includes rotomolding, the melt processing may include rotomolding at 0 psi to 100 psi, and at temperatures in a range of 200° C. to 370° C. (392° F. to 698° F.).

In some embodiments wherein the melt processing of the processed polymer includes extruding, the melt processing may include extruding at 1 psi to 3000 psi and at temperatures in a range of 150° C. to 380° C. (302° F. to 716° F.).

In some embodiments wherein the melt processing of the processed polymer includes calendaring, the melt processing may include calendaring at 1 psi to 3000 psi, in a range of 1 kilograms per hour (kg/hr) to 1000 kg/hr, and/or at temperatures in a range of 150° C. to 380° C. (302° F. to 716° F.).

In some embodiments wherein the melt processing of the processed polymer includes blow molding, the melt processing may include blow molding at temperatures in a range of 150° C. to 380° C. (302° F. to 716° F.).

In some embodiments wherein the melt processing of the processed polymer includes thermoforming, the melt processing may include thermoforming at temperatures in a range of 150° C. to 380° C. (302° F. to 716° F.).

In some embodiments wherein the melt processing of the processed polymer includes compression molding, the melt processing may include compression molding at temperatures in a range of 150° C. to 380° C. (302° F. to 716° F.).

In some embodiments wherein the melt processing of the processed polymer includes fiber spinning, the melt processing may include fiber spinning at temperatures in a range of 150° C. to 380° C. (302° F. to 716° F.). In some embodiments wherein the melt processing of the processed polymer includes fiber spinning, the processing may include using a gel solvent.

In some embodiments wherein the melt processing of the processed polymer includes foaming, the melt processing may include foaming at temperatures in a range of 150° C. to 380° C. (302° F. to 716° F.).

In some embodiments, the processed polymer may be used as an additive including, for example, as a melt-strength additive.

### EMBODIMENTS

### Exemplary Methods of Making Sheared Polymer Composition Embodiments

### Embodiment 1

A method comprising:

applying a shear force to a starting polymer composition comprising a polyolefin having a weight average molecular weight (M_{w}) of at least 7.5×10⁵ g/mol to form a sheared polymer composition.

### Embodiment 2

The method of Embodiment 1 wherein applying shear force to the starting polymer composition comprises applying a shear force performed at a temperature less than the melting point of the starting polymer composition.

### Embodiment 3

The method of either Embodiment 1 or Embodiment 2 wherein the starting polymer composition has a weight average molecular weight (M_{w}) of at least 1×10⁶ g/mol, at least 2×10⁶ g/mol, at least 3×10⁶ g/mol, at least 4×10⁶ g/mol, at least 5×10⁶ g/mol, at least 6×10⁶ g/mol, at least 7×10⁵ g/mol, or at least 8×10⁶ g/mol.

### Embodiment 4

The method of any of Embodiments 1 to 3 wherein applying a shear force to the starting polymer composition comprises applying a specific energy of at least 0.2 kw*hr/kg, at least 0.4 kw*hr/kg, at least 0.6 kw*hr/kg, or at least 0.8 kw*hr/kg.

### Embodiment 5

The method of any of Embodiments 1 to 4 wherein applying a shear force to the starting polymer composition comprises applying a shear rate of at least 25 sec⁻¹, at least 50 sec⁻¹, at least 100 sec⁻¹, at least 250 sec⁻¹, or at least 500 sec⁻¹.

### Embodiment 6

The method of any of Embodiments 1 to 5 wherein the sheared polymer composition has a lower weight average molecular weight (M_{w}) than the starting polymer composition.

### Embodiment 7

The method of any of Embodiments 1 to 6 wherein the weight average molecular weight (M_{w}) of the sheared polymer composition is at least 10%, at least 20%, at least 30%, at least 40%, at least 50%, at least 60%, or at least 70% lower than the M_{w} of the starting polymer composition.

### Embodiment 8

The method of any of Embodiments 1 to 7 wherein the sheared polymer composition has a lower polydispersity index (PDI) than the PDI of the starting polymer composition.

### Embodiment 9

The method of any of Embodiments 1 to 8 wherein polydispersity index (PDI) of the sheared polymer composition is at least 10%, at least 20%, at least 30%, at least 40%, at least 50%, at least 60%, or at least 70% lower than a PDI of the starting polymer composition.

### Embodiment 10

The method of any of Embodiments 1 to 9 wherein the sheared polymer composition has a polydispersity index (PDI) of less than 5, less than 4, less than 3.5, less than 3, less than 2.5, or less than 2.

### Embodiment 11

The method of any of Embodiments 1 to 10, wherein the polyolefin of the starting polymer composition comprises a polyethylene or a polypropylene or a combination thereof.

### Embodiment 12

The method of any of Embodiments 1 to 10, wherein the starting polymer composition further comprises a polytetrafluoroethylene, a polystyrene, a polyvinylchloride, or a polyester, or a combination thereof.

### Embodiment 13

The method of any of Embodiments 1 to 12, wherein the starting composition or the sheared composition or both the starting composition and the sheared composition comprise an additive.

### Embodiment 14

The method of Embodiment 13, wherein the additive comprises a filler, a thermal stabilizer, a UV stabilizer, an antioxidant, a dye, a pigment, a colorant, an oil, or a lubricant, or a combination thereof.

### Embodiment 15

The method of any of Embodiments 1 to 14, wherein applying a shear force to a starting polymer composition comprises exposing the starting polymer composition to a mixer.

### Embodiment 16

The method of any of Embodiments 1 to 15, wherein applying a shear force to a starting polymer composition comprises solid-state shear pulverization (SSSP).

### Embodiment 17

The method of any of Embodiments 1 to 15, wherein applying a shear force to a starting polymer composition comprises solid-state/melt extrusion (SSME).

### Embodiment 18

The method of any of Embodiments 1 to 17 wherein the sheared polymer composition has a weight average molecular weight (M_{w}) of at least 3×10⁵ g/mol, at least 4×10⁵ g/mol, at least 5×10⁵ g/mol, at least 6×10⁵ g/mol, at least 7×10⁵ g/mol, or at least 8×10⁵ g/mol.

### Embodiment 19

The method of any of Embodiments 1 to 18, wherein the sheared polymer is melt processable.

### Embodiment 20

The method of any of Embodiments 1 to 19, wherein the sheared polymer is injection moldable.

### Embodiment 21

The method of any of Embodiments 1 to 20, the method further comprising forming a powder comprising the sheared polymer.

### Exemplary Methods of Making Processed Polymer Embodiments

### Embodiment 1

A method comprising:

applying a shear force to a starting polymer composition comprising a polymer having a weight average molecular weight (M_{w}) of at least 7.5×10⁵ g/mol to form a sheared polymer composition; and

treating the sheared polymer composition to form a processed polymer composition.

### Embodiment 2

The method of Embodiment 1 wherein applying shear force to the starting polymer composition comprises applying a shear force at a temperature less than the melting point of the polymer composition.

### Embodiment 3

The method of either Embodiment 1 or Embodiment 2 wherein the starting polymer composition has a weight average molecular weight (M_{w}) of at least 1×10⁶ g/mol, at least 2×10⁶ g/mol, at least 3×10⁶ g/mol, at least 4×10⁶ g/mol, at least 5×10⁶ g/mol, at least 6×10⁶ g/mol, at least 7×10⁵ g/mol, or at least 8×10⁶ g/mol.

### Embodiment 4

The method of any of Embodiments 1 to 3 wherein applying a shear force to the polymer composition comprises applying a specific energy of at least 0.2 kw*hr/kg, at least 0.4 kw*hr/kg, at least 0.6 kw*hr/kg, or at least 0.8 kw*hr/kg.

### Embodiment 5

The method of any of Embodiments 1 to 4 wherein applying a shear force to the starting polymer composition comprises applying a shear rate of at least 25 sec⁻¹, at least 50 sec⁻¹, at least 100 sec⁻¹, at least 250 sec⁻¹, or at least 500 sec⁻¹.

### Embodiment 6

The method of any of Embodiments 1 to 5 wherein the sheared polymer composition has a lower weight average molecular weight (M_{w}) than the starting polymer composition.

### Embodiment 7

The method of any of Embodiments 1 to 6 wherein weight average molecular weight (M_{w}) of the sheared polymer composition is at least 10%, at least 20%, at least 30%, at least 40%, at least 50%, at least 60%, or at least 70% lower than the M_{w} of the starting polymer composition.

### Embodiment 8

The method of any of Embodiments 1 to 7 wherein

the sheared polymer composition has a lower polydispersity index (PDI) than the PDI of the starting polymer composition, or

the processed polymer composition has a lower PDI than the PDI of the sheared polymer composition, or

the sheared polymer composition has a lower PDI than the PDI of the starting polymer composition and the processed polymer composition has a lower PDI than the PDI of the sheared polymer composition.

### Embodiment 9

The method of any of Embodiments 1 to 8 wherein the polydispersity index (PDI) of the sheared polymer composition is at least 10%, at least 20%, at least 30%, at least 40%, at least 50%, at least 60%, or at least 70% lower than the PDI of the starting polymer composition.

### Embodiment 10

The method of any of Embodiments 1 to 9 wherein the sheared polymer composition has a polydispersity index (PDI) of less than 5, less than 4, less than 3.5, less than 3, less than 2.5, or less than 2.

### Embodiment 11

The method of any of Embodiments 1 to 10 wherein the starting polymer composition comprises a polyolefin, a polytetrafluoroethylene, a polystyrene, a polyvinylchloride, or a polyester, or a combination thereof.

### Embodiment 12

The method of any of Embodiments 1 to 11 wherein the starting polymer composition comprises a polyolefin.

### Embodiment 13

The method of any of Embodiments 1 to 12, wherein applying a shear force to a starting polymer composition comprises exposing the starting polymer composition to a mixer.

### Embodiment 14

The method of any of Embodiments 1 to 13, wherein applying a shear force to a starting polymer composition comprises solid-state shear pulverization (SSSP).

### Embodiment 15

The method of any of Embodiments 1 to 13, wherein applying a shear force to a starting polymer composition comprises solid-state/melt extrusion (SSME).

### Embodiment 16

The method of any of Embodiments 1 to 15, wherein the sheared polymer composition has a weight average molecular weight (M_{w}) of at least 3×10⁵ g/mol, at least 4×10⁵ g/mol, at least 5×10⁵ g/mol, at least 6×10⁵ g/mol, at least 7×10⁵ g/mol, or at least 8×10⁵ g/mol.

### Embodiment 17

The method of any of Embodiments 1 to 16, wherein treating the sheared polymer composition to form a processed polymer composition comprises treating the sheared polymer composition produce a processed polymer composition having a weight average molecular weight (M_{w}) that is at least 20%, at least 30%, at least 40%, at least 50%, at least 60%, at least 70%, at least 80%, or at least 90% lower than the M_{w} of the sheared polymer composition.

### Embodiment 18

The method of any of Embodiments 1 to 17, wherein the processed polymer composition has a weight average molecular weight (M_{w}) that is at least 20%, at least 30%, at least 40%, at least 50%, at least 60%, at least 70%, at least 80%, or at least 90% lower than the M_{w} of the sheared polymer composition.

### Embodiment 19

The method of any of Embodiments 1 to 18, wherein treating the sheared polymer composition to form a processed polymer composition comprises decreasing the polydispersity index (PDI).

### Embodiment 20

The method of any of Embodiments 1 to 19, wherein treating the sheared polymer composition to form a processed polymer composition decreases the polydispersity index (PDI) by at least 10%, at least 20%, at least 30%, at least 40%, at least 50%, or at least 60%.

### Embodiment 21

The method of any of Embodiments 1 to 19, wherein the processed polymer composition has a polydispersity index (PDI) of at least 10%, at least 20%, at least 30%, at least 40%, at least 50%, or at least 60% lower than a PDI of the sheared polymer composition.

### Embodiment 22

The method of any of Embodiments 1 to 21, wherein treating the sheared polymer composition to form the processed polymer composition does not change the z average molecular weight (M_{z}) of the sheared polymer more than 10%, more than 20%, more than 25%, more than 30%, more than 35%, or more than 40%.

### Embodiment 23

The method of any of Embodiments 1 to 22, wherein the processed polymer composition has a z average molecular weight (M_{z}) of no more than 10%, no more than 20%, no more than 25%, no more than 30%, no more than 35%, or no more than 40% of the M_{z} of the sheared polymer.

### Embodiment 24

The method of any of Embodiments 1 to 23, wherein treating the sheared polymer comprises treating the sheared polymer so that the processed polymer has a melt flow index of at least 0.01, at least 0.03, at least 0.05, at least 0.07, at least 0.1, at least 0.2, at least 0.4, at least 0.9, at least 1, at least 1.5, at least 1.7, or at least 2.

### Embodiment 25

The method of any of Embodiments 1 to 24, wherein the processed polymer has a melt flow index of at least 0.01, at least 0.03, at least 0.05, at least 0.07, at least 0.1, at least 0.2, at least 0.4, at least 0.9, at least 1, at least 1.5, at least 1.7, or at least 2.

### Embodiment 26

The method of any of Embodiments 1 to 25, wherein treating the sheared polymer composition comprises treating the sheared polymer composition so that the processed polymer has a toughness of at least 115,000 psi, wherein the toughness is the area under a stress-strain curve measured from 0% to 40% elongation, using Type 1 tensile specimens of the processed polymer conditioned for at least 40 hours at 23° C. and 50% relative humidity (procedure A) and pulled at 2 inches/minute (50.8 mm/min) according to ASTM D-638-14.

### Embodiment 27

The method of any of Embodiments 1 to 24, wherein the processed polymer has a toughness of at least 115,000 psi, wherein the toughness is the area under a stress-strain curve measured from 0% to 40% elongation, using Type 1 tensile specimens of the processed polymer conditioned for at least 40 hours at 23° C. and 50% relative humidity (procedure A) and pulled at 2 inches/minute (50.8 mm/min) according to ASTM D-638-14.

### Embodiment 28

The method of any of the Embodiments 1 to 27 wherein treating the sheared polymer composition comprises heating the sheared polymer composition to at least 100° C., at least 110° C., at least 120° C., at least 130° C., at least 140° C., at least 150° C., at least 160° C., at least 170° C., at least 180° C., at least 210° C., or at least 230° C. greater than the melting point of the starting polymer composition.

### Embodiment 29

The method of any of Embodiments 1 to 28 wherein treating the sheared polymer composition comprises heating the sheared polymer composition to a temperature of up to 250° C., up to 300° C., up to 400° C., up to 430° C., up to 440° C., up to 450° C., up to 500° C., or up to 550° C.

### Embodiment 30

The method of any of Embodiments 1 to 29 wherein treating the sheared polymer composition comprises applying a shear force to the sheared polymer composition.

### Embodiment 31

The method of any of Embodiments 1 to 30, wherein applying a shear force to the sheared polymer composition comprises exposing the sheared polymer composition to a mixer.

### Embodiment 32

The method of any of Embodiments 1 to 31, wherein treating the sheared polymer composition comprises solid-state/melt extrusion (SSME).

### Embodiment 33

The method of any of Embodiments 1 to 32, wherein the processed polymer composition has a weight average molecular weight (M_{w}) of at least 20%, at least 30%, at least 40%, at least 50%, at least 60%, at least 70%, at least 80%, or at least 90% less than a weight average molecular weight (M_{w}) of the starting polymer composition.

### Embodiment 34

The method of any of Embodiments 1 to 33, the method further comprises cooling the processed polymer to room temperature.

### Embodiment 35

The method of any of Embodiments 1 to 34, wherein at least one of the starting polymer composition, the sheared polymer composition, and the processed polymer composition comprises an additive.

### Embodiment 36

The method of Embodiment 35, wherein the additive comprises a filler, a thermal stabilizer, a UV stabilizer, an antioxidant, a dye, a pigment, a colorant, an oil, or a lubricant, or a combination thereof.

### Embodiment 37

The method of any of Embodiments 1 to 34, wherein at least one of the starting polymer composition, the sheared polymer composition, and the processed polymer composition comprises less than 100 ppm of a gel solvent residue, less than 50 ppm of a gel solvent residue, less than 25 ppm of a gel solvent residue, less than 10 ppm of a gel solvent residue, or less than 1 ppm of a gel solvent residue.

### Embodiment 38

The method of any of Embodiments 1 to 37 wherein the starting polymer composition consists essentially of a polymer having a molecular weight of at least 7.5×10⁵ g/mol.

### Embodiment 39

The method of any of Embodiments 1 to 37 wherein the starting polymer composition consists of a polymer having a molecular weight of at least 7.5×10⁵ g/mol.

### Embodiment 40

The method of any of Embodiments 1 to 37 wherein the starting polymer composition consists of a polyolefin having a molecular weight of at least 7.5×10⁵ g/mol.

### Embodiment 41

The method of any of Embodiments 1 to 40 further comprising extruding the processed polymer composition.

### Embodiment 42

The method of Embodiment 41 further comprising forming pellets from processed polymer composition.

### Embodiment 43

The method of any of Embodiments 1 to 42, wherein the processed polymer composition is melt processable.

### Embodiment 44

The method of any of Embodiments 1 to 42, wherein the processed polymer composition is injection moldable.

### Exemplary Composition Embodiments

### Embodiment 1

A sheared polymer composition comprising a polymer, wherein the composition is characterized by

a contraction factor (g′) in a range of 0.999 to 0.850 for polymers having molecular weights (MW) in a range of 1×10⁴ g/mol to 1×10⁸ g/mol.

### Embodiment 2

A sheared polymer composition comprising a polymer, wherein the composition is characterized by

a polydispersity index (PDI) of up to 4, and

a storage modulus plateau at 150° C. of at least 1 MPa.

### Embodiment 3

The composition of Embodiment 1 or 2, wherein the composition has weight average molecular weight (M_{w}) of at least 5×10⁵ g/mol, at least 7.5×10⁵ g/mol, at least 1×10⁶ g/mol, at least 1.5×10⁶ g/mol, or at least 2×10⁶ g/mol.

### Embodiment 4

The composition of any of Embodiments 1 to 3 wherein the composition has a weight average molecular weight (M_{w}) of up to 1×10⁶ g/mol, up to 1.5×10⁶ g/mol, up to 2×10⁶ g/mol, up to 2.5×10⁶ g/mol, up to 3×10⁶ g/mol, or up to 3.5×10⁶ g/mol.

### Embodiment 5

The composition of any of Embodiments 1 to 4 wherein the composition has a storage modulus plateau at 150° C. of at least 1 MPa, at least 1.25 MPa, or at least 1.5 MPa.

### Embodiment 6

A composition comprising a processed polymer wherein the composition has a complex viscosity in a range of 1×10⁴ Pa·s to 1×10⁸ Pa·s at 1×10⁻² rad/s.

### Embodiment 7

A processed polymer composition comprising a polymer wherein the composition has a toughness of at least 115,000 psi, wherein the toughness is the area under a stress-strain curve measured from 0% to 40% elongation, using Type 1 tensile specimens of the composition conditioned for at least 40 hours at 23° C. and 50% relative humidity (procedure A) and pulled at 2 inches/minute (50.8 mm/min) according to ASTM D-638-14.

### Embodiment 8

The composition of Embodiment 7 wherein the composition is injection moldable.

### Embodiment 9

The composition of any of Embodiments 6 to 8 wherein the composition has a weight average molecular weight (M_{w}) of up to 1×10⁵ g/mol, up to 1.5×10⁵ g/mol, up to 2×10⁵ g/mol, up to 3×10⁵ g/mol, up to 4×10⁵ g/mol, or up to 5×10⁵ g/mol.

### Embodiment 10

The composition of any of Embodiments 6 to 9, wherein the composition has a melt flow index of

at least 0.01, at least 0.03, at least 0.05, at least 0.07, at least 0.1, at least 0.2, at least 0.4, or at least 0.5, and/or

up to 0.6, up to 0.8, up to 1, or up to 2.

### Embodiment 11

The composition of any of Embodiments 1 to 10 wherein the composition has a polydispersity index (PDI) of up to 2.5, up to 3, up to 3.5, or up to 4.

### Embodiment 12

The composition of any of Embodiments 1 to 11 wherein the polymer comprises a polyolefin.

### Embodiment 13

The composition of any of Embodiments 1 to 12 wherein the polymer comprises a polyethylene.

### Embodiment 14

The composition of any of Embodiments 1 to 13 wherein the composition has a z average molecular weight (M_{z}) of up to 5×10⁶ g/mol, up to 6×10⁶ g/mol, up to 7×10⁶ g/mol, or up to 7.5×10⁶ g/mol.

### Embodiment 15

The composition of any of Embodiments 1 to 14 wherein the polymer composition has a complex viscosity of at least 1×10⁴ Pa·s, at least 1×10⁵ Pa·s, at least 1×10⁶ Pa·s, at least 1×10⁷ Pa·s, or at least 1×10⁸ Pa·s at 10⁻² rad/s.

### Embodiment 16

The composition of any of Embodiments 1 to 15 wherein the composition has a toughness of at least 115,000 psi, wherein the toughness is the area under a stress-strain curve measured from 0% to 40% elongation, using Type 1 tensile specimens of the composition conditioned for at least 40 hours at 23° C. and 50% relative humidity (procedure A) and pulled at 2 inches/minute (50.8 mm/min) according to ASTM D-638-14.

### Embodiment 17

The composition of any of Embodiments 1 to 16 wherein the composition has a static coefficient of friction of less than 0.3, less than 0.25, or less than 0.2, wherein the static coefficient of friction is measured according to ASTM D-1894-14.

### Embodiment 18

The composition of any of Embodiments 1 to 17 wherein the composition has a dynamic coefficient of friction of less than 0.3, less than 0.25, or less than 0.2, wherein the dynamic coefficient of friction is measured according to ASTM D-1894-14.

### Embodiment 19

The composition of any of Embodiments 1 to 18 wherein the composition comprises less than 100 ppm of a gel solvent, less than 50 ppm of a gel solvent, less than 25 ppm of a gel solvent, less than 10 ppm of a gel solvent, or less than 1 ppm of a gel solvent.

### Embodiment 20

The composition of any of Embodiments 1 to 19 wherein the composition comprises less than 100 ppm of a gel solvent residue, less than 50 ppm of a gel solvent residue, less than 25 ppm of a gel solvent residue, less than 10 ppm of a gel solvent residue, or less than 1 ppm of a gel solvent residue.

### Embodiment 21

The composition of Embodiments 19 or 20 wherein the gel solvent comprises decalin or paraffin oil.

### Embodiment 22

The composition of any of Embodiments 1 to 21 wherein the composition further comprises an additive.

### Embodiment 23

The composition of Embodiment 22 wherein the additive comprises a filler, a thermal stabilizer, a UV stabilizer, an antioxidant, a dye, a pigment, a colorant, an oil, or a lubricant, or a combination thereof.

### Embodiment 24

A molded article comprising the composition of any of Embodiments 1 to 23.

### Embodiment 25

A fiber comprising the composition of any of Embodiments 1 to 23.

### Embodiment 26

A tape comprising the composition of any of Embodiments 1 to 23.

### Embodiment 27

A blown film comprising the composition of any of Embodiments 1 to 23.

### Embodiment 28

An extruded tubing comprising the composition of any of Embodiments 1 to 23.

### Embodiment 29

A method comprising melt processing the composition of any of Embodiments 1 to 23.

### Exemplary Method of using Embodiments

### Embodiment 1

A method comprising melt processing a composition comprising a processed polymer, wherein the composition is characterized by

a complex viscosity in a range of 1×10⁴ to 1×10⁸ Pa·s at 10⁻² rad/s;

a melt flow index of up to 0.6, up to 0.8, up to 1, or up to 2; and

a weight average molecular weight (M_{w}) of up to 1×10⁵ g/mol, up to 2×10⁵ g/mol, up to 3×10⁵ g/mol, up to 4×10⁵ g/mol, or up to 5×10⁵ g/mol.

### Embodiment 2

A method comprising melt processing a composition comprising a processed polymer comprising a polyethylene, wherein the composition is characterized by

a toughness of at least 115,000 psi, wherein the toughness is the area under a stress-strain curve measured from 0% to 40% elongation, using Type 1 tensile specimens of the composition conditioned for at least 40 hours at 23° C. and 50% relative humidity (procedure A) and pulled at 2 inches/minute (50.8 mm/min) according to ASTM D-638-14; and

a weight average molecular weight (M_{w}) of up to 1.5×10⁵ g/mol, up to 2×10⁵ g/mol, up to 3×10⁵ g/mol, or up to 4×10⁵ g/mol.

### Embodiment 3

The method of Embodiment 1 or 2 wherein melt processing the composition comprises injection molding the composition in a range of 100 psi to 25,000 psi and in a range of 150° C. to 380° C.

### Embodiment 4

The method of Embodiment 1 or 2 wherein melt processing the composition comprises extruding the composition in a range of 1 psi to 3000 psi and in a range of 150° C. to 380° C.

### Embodiment 5

The method of Embodiment 1 or 2 wherein melt processing the composition comprises calendaring the composition in a range of 1 psi to 3000 psi, in a range of 1 kg/hr to 1000 kg/hr, and in a range of 150° C. to 380° C.

### Embodiment 6

The method of Embodiment 1 or 2 wherein melt processing the composition comprises blow molding the composition in a range of 150° C. to 380° C.

### Embodiment 7

The method of Embodiment 1 or 2 wherein melt processing the composition comprises thermoforming the composition in a range of 150° C. to 380° C.

### Embodiment 8

The method of Embodiment 1 or 2 wherein melt processing the composition comprises compression molding the composition at 150° C. to 380° C.

### Embodiment 9

The method of Embodiment 1 or 2 wherein melt processing the composition comprises fiber spinning the composition at 150° C. to 380° C.

### Embodiment 10

The method of Embodiment 1 or 2 wherein melt processing the composition comprises foaming the composition at 150° C. to 380° C.

### Embodiment 11

A method comprising processing a composition comprising a sheared polymer, wherein the composition has

a weight average molecular weight (M_{w}) of at least 5×10⁵ g/mol,

a polydispersity index (PDI) of up to 4, and

a contraction factor (g′) in a range of 0.999 to 0.850 for polymers having molecular weights (MW) in a range of 1×10⁴ g/mol to 1×10⁸ g/mol.

### Embodiment 12

The method of claim 11, wherein the composition has a z average molecular weight (M_{z}) of up to 7.5×10⁶ g/mol.

### Embodiment 13

A method comprising processing a composition comprising a sheared polymer, wherein the composition has

a polydispersity index (PDI) of up to 4, and

a storage modulus plateau at 150° C. of at least 1 MPa.

### Embodiment 14

The method of any of Embodiments 11 to 13 wherein processing the composition comprises gel processing.

### Embodiment 15

The method of any of Embodiments 11 to 13 wherein processing the composition comprises fiber spinning the composition using a gel solvent.

### Embodiment 16

The method of any of Embodiments 11 to 13 wherein processing the composition comprises compression molding the composition.

### Embodiment 17

The method of any of Embodiments 11 to 13 wherein processing the composition comprises extruding the composition.

### EXAMPLES

Objects and advantages of this disclosure are further illustrated by the following examples, but the particular materials and amounts thereof recited in these examples, as well as other conditions and details, should not be construed to unduly limit this disclosure.

### Preparation and Test Procedures

### General Process Description

The materials are fed into a 150 hp intermeshing, co-rotating twin-screw extruder (ZSK-70) made by Werner and Pfleiderer (now Coperion GmbH, Stuttgart, Germany). The twin-screw extruder, or pulverizer, has a diameter (D) of 70 mm throughout its entire length and a length to diameter ratio (L/D) of 16. The screws are modular in nature and designed as a combination of spiral conveying and bilobe kneading or pulverization elements. A harsh screw configuration including more than three neutral and reverse pulverization elements is employed.

Throughout the process duration, the barrels and shafts are cooled by recirculating a propylene glycol/water (40/60 vol/vol) mixture maintained at −5° C. to 35° C. (23° F. to 95° F.) by a chiller with a 30 ton Copeland compressor (Emerson Climate Technologies, Sidney Ohio). The flow rate of coolant through the pulverization apparatus is set at 20 gallons per minute (gpm) to 30 gpm. The screw rotation speed is maintained constant at 200 rpm, imparting a load on the motor of 30% to 35%. Material is fed into the pulverization apparatus at room temperature, or 25° C. (77° F.), using a Schenk volumetric feeder (Schenck Process, Whitewater, Wis.). The material passes through the pulverizer at a rate of 75 kg/hr and increases in temperature so that once exiting the pulverizer it has increased in its temperature in a range of 125° C. to 230° C. (257° F. to 446° F.). An energy meter on the coolant system indicates that 120 kBTU/hr to 140 kBTU/hr is removed from the pulverizer during steady state processing.

After pulverization, the material is conveyed by a K-Tron volumetric feeder (K2T60, Coperion, Stuttgart, Germany) into a 50 hp, 63.5 mm Welex Model 250 single-screw melt extruder having an L/D of 24/1 (Welex, York, Pa.). The barrel, die adaptor, and die head temperatures are maintained at 335° C. to 360° C. (635° F. to 680° F.), shown as the “Process Temperature” in Table 1. The throughput is 75 kg/hr and motor load at 25%. The die pressure is kept to a value less than 10 MPa. Room temperature water is used to help control temperature around barrels and within the screw shaft. The output of the melt-extruded material is then passed through a water trough held at 20° C. to 50° C. (68° F. to 122° F.) and then cut into pellets using a rotary pelletizer, Model ASG-10 (Automatik Plastics Machinery, now Maag, a Dover Company).

### Injection Molding ASTM Test Specimens

Test specimens were injection molded in a KM40-125 injection molding machine (Krauss Maffei, Munich, Germany) fitted with a 25 mm screw and having a clamping force of 45 tons. The following molding parameters were used:
Fill time—0.97 seconds
Fill/pack pressure—12,500 psi
Pack time—6 seconds
Cool time—9 seconds
Barrel temperature—246° C. (475° F.)
Back pressure—500 psi
Screw Speed—150 rpm
Mold Temp—60° C. (140° F.)
Shot size—1.25 ounces (oz)

### Abrasion Testing

Abrasion testing was performed on a GS-59-396 apparatus (Custom Scientific Instruments, Easton, Pa.) with a 1-in² 100 grit abrasive. Injection molded disks were exposed to 1300 cycles, approximately 10 minutes, and their mass loss recorded. Resulting data represents average mass loss over at least 5 test specimens.

### Stress/Strain Measurements

Tensile properties of the polymers were measured using Type 1 tensile specimens of the processed polymer conditioned for at least 40 hours at 23° C. and 50% relative humidity (procedure A) and pulled at 2 inches/minute (50.8 mm/min) according to ASTM D-638-14. As used herein, “toughness” refers to the area under the measured stress-strain curve within a stated elongation range.

### Calorimetry

Differential scanning calorimetry data were collected on a Shimadzu DSC-50A (Shimadzu Corporation, Kyoto, Japan) set to a ramp rate of 20° C. per minute. Sample sizes ranged from 3.0 milligrams (mg) to 5.0 mg and were run in triplicate.

### Fourier Transform Infrared Spectroscopy

Fourier transfer infrared spectroscopy was performed on a Nicolet iS5 spectrometer (Thermo Fisher Scientific, Minneapolis, Minn.) fitted with an iD5 ATR crystal and running at 1.0 cm⁻¹ resolution.

### Gel Permeation Chromatography (GPC)

Sample solutions ranging from 0.5 to 0.8 mg/mL were prepared using a PL-SP260 High Temperature Sample Preparation System (Agilent Technologies, Santa Clara, Calif.). The samples were heated to 160° C. and allowed to dissolve overnight (˜16 hours) in trichlorobenzene. The samples were then gently agitated for 30 minutes ensure homogenization. After agitation, the samples were transferred to autosampler vials using a pipettor equipped with a 1 micrometer (μm) glass fiber filter. Sample analysis was carried out on a Viscotek 350B HT-GPC (Malvern Instruments, Malvern, UK). The instrument is equipped with a Viscotek TDA 305 detector suite with integrated refractive index, light scattering (830 nanometers (nm) at 90 degrees) (°) and 7°), and differential viscometer detectors. The system is also equipped with a 200 microliter (μL) injection sample loop and CLM6210-HTx3 three column set from Malvern Instruments operated at 160° C. with a flow rate of 1 milliliter per minute (mL/min). The data is analyzed using OmniSEC software (Malvern Instruments, Malvern, UK). For triple detection, a 105 K polystyrene narrow standard was used to set the calibration constants used in the OmniSEC GPC software (Malvern Instruments, Malvern, UK).

### Dynamic Mechanical Analysis

Dynamic mechanical analysis was used to determine the storage modulus for Examples 52 to 54. Rectangular samples were compression molded and then ground to approximately 35 mm×12.7 mm×1.8 mm. The samples were loaded into a rectangular torsion geometry installed on a rheometer (DHR-2, TA Instruments, New Castle, Del.). An oscillatory temperature ramp was conducted from 25° C. to 165° C. at a ramp rate of 1° C./min. A soak time of 10 seconds was applied after each temperature step. The frequency was set to 1 hertz (Hz) and the strain was set to 0.2%. An axial force of 10 N was maintained during testing to prevent sample buckling. Storage modulus is reported as a function of temperature.

### Small Angle Oscillatory Shear (SAOS)

Small angle oscillatory shear (SAOS) was used to determine the complex viscosity, storage modulus, and loss modulus for Examples 2 and 4. Samples were compression molded into discs of approximately 25 mm (diameter)×1 mm. The samples were loaded into a 25 mm parallel plate geometry installed on a rheometer (DHR-2, TA Instruments, New Castle, Del.). First, strain sweeps were conducted at a frequency of 10 rad/s and 200° C. to determine the oscillatory strain suitable for SAOS testing within the linear viscoelastic region of each sample. SAOS testing was conducted at a temperature of 150° C. at oscillatory strain of 1% over a frequency range of 250 rad/s to 0.01 rad/s. Complex viscosity at a frequency of 0.01 rad/s and at a temperature of 150° C. is reported.

### Izod Impact Analysis

Notched Izod impact testing was performed in accordance with ASTM D 4020, Appendix X1, with the exception that the specimens ranged from 3.0 mm to 3.3 mm in thickness and specimens other than the UHMWPE control were injection molded. Specimens were allowed to condition for a minimum period of 40 hours at 23° C.+/−2° C. and 50%+/−10% relative humidity. Five to ten specimens were tested each test sample evaluated. Testing was performed at ambient laboratory conditions of 23° C.+/−2° C. and 50%+/−10% relative humidity on a pendulum test instrument. For this method, a hammer with a total energy of 2 Joules (J) was utilized. The windage for the testing was 0.016 J.

### Preparation and Testing

### Example 1

In this comparative example, which shows the properties of UHMWPE that has not been processed according to the methods described herein, compression molded polyethylene was prepared by placing 20 grams of UHMWPE powder (Lupolen UHM 5000, LyondellBasell Industries N.V., Houston, Tex.) in stainless steel mold. The mold was placed into a heated press (Carver model C, Carver, Inc., Wabash, Ind.) set to 150° C. The mold and its contents were placed under 100 psi of pressure then allowed to equilibrate for 10 minutes. After that time, the mold was moved to a second cold press (Carver model K, Carver, Inc., Wabash, Ind.) and placed under 10 tons of pressure. The mold was allowed to cool for another 10 minutes, at room temperature, after which the molded polyethylene was removed. Furthermore, the compression molded specimen was allowed to sit at room temperature for 48 hours before testing. Properties of the polyethylene are provided in Table 1.

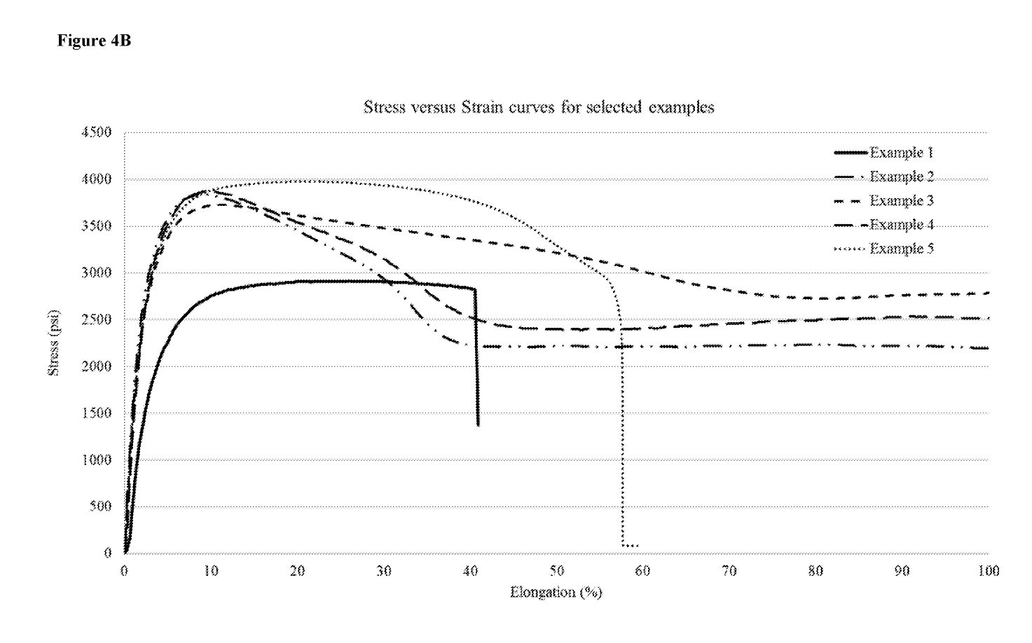

FIG. 4 shows stress versus strain curves for the polyethylene of Example 1. For the material of Example 1, which was not processed using the methods described herein, the material does not display a yield, and fails at 40% elongation. The area under the stress-strain curve in FIG. 4A, the toughness, as measured from 0% elongation to 40% elongation for the material of Example 1, is less than 115,000 psi.

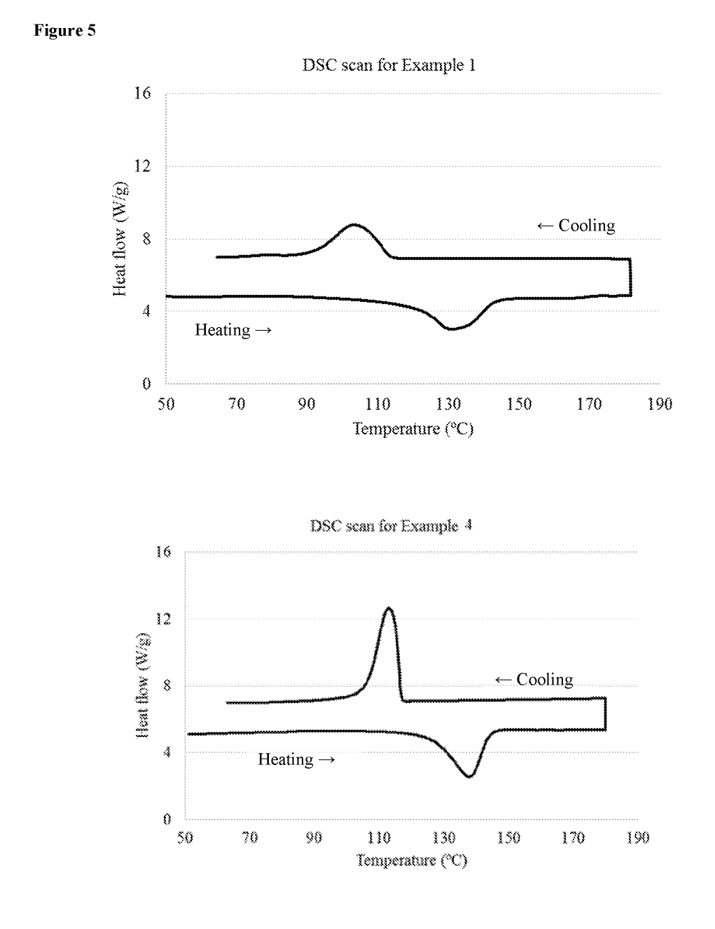

FIG. 5 shows differential scanning calorimetry results for the material of Example 1.

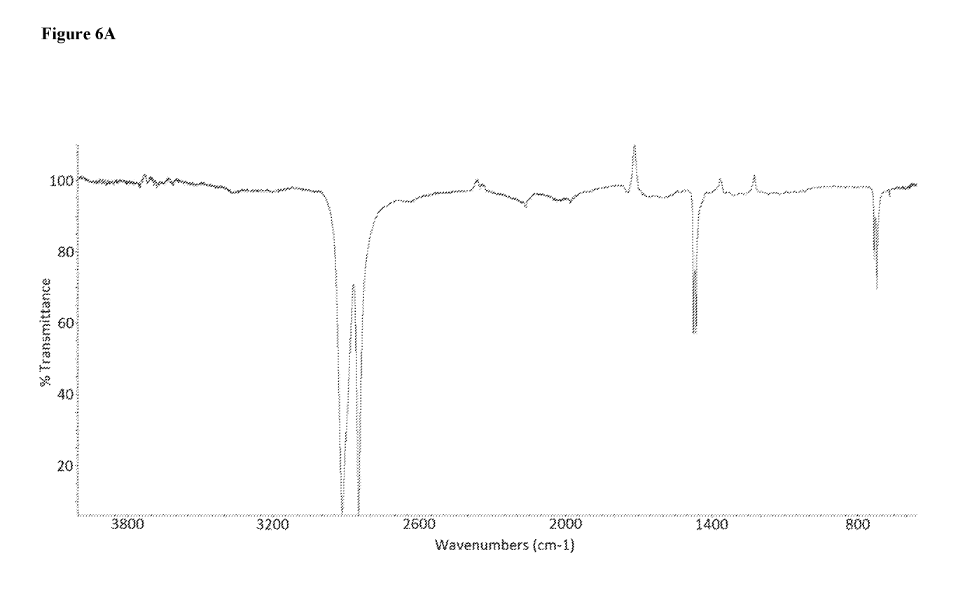

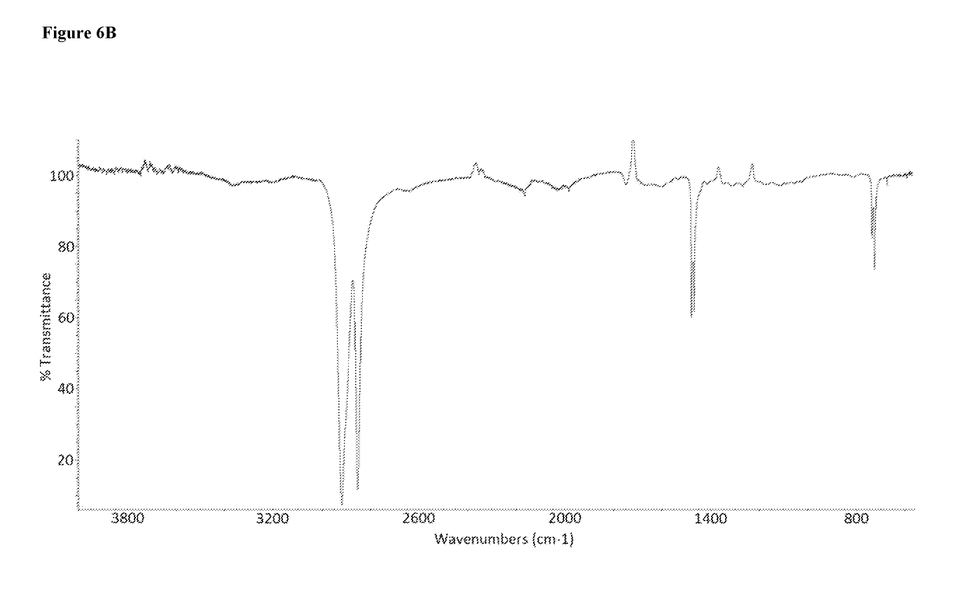

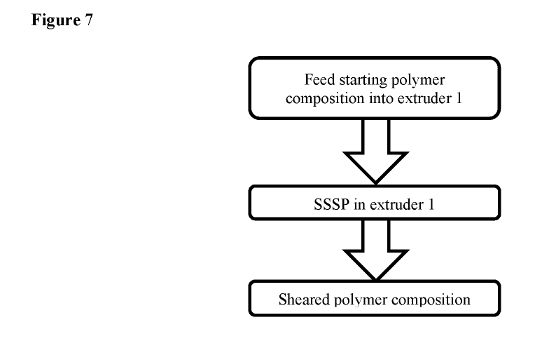

FIG. 6A shows a Fourier transform infrared spectroscopy scan of a compression molded film of the polyethylene of Example 1.

### Examples 2-4

Polyethylene having an improved melt flow index was made from a polyethylene having a molecular weight of 5×10⁶ g/mol (Lupolen UHM 5000, LyondellBasell Industries N.V., Houston, Tex.) using the General Process. Test specimens were injection molded into shapes according to their appropriate analysis as specified by the test method. Properties of the resulting polyethylene are provided in Table 1.

FIG. 4 shows stress versus strain curves for the polyethylene of Examples 2 through 4. The area under the stress-strain curve in FIG. 4A, the toughness, measured from 0% elongation to 40% elongation is at least 115,000 psi.

FIG. 5 shows differential scanning calorimetry curves for Example 4.

FIG. 6B shows Fourier transform infrared spectroscopy scans for an injection molded disk of the polymer of Example 4.

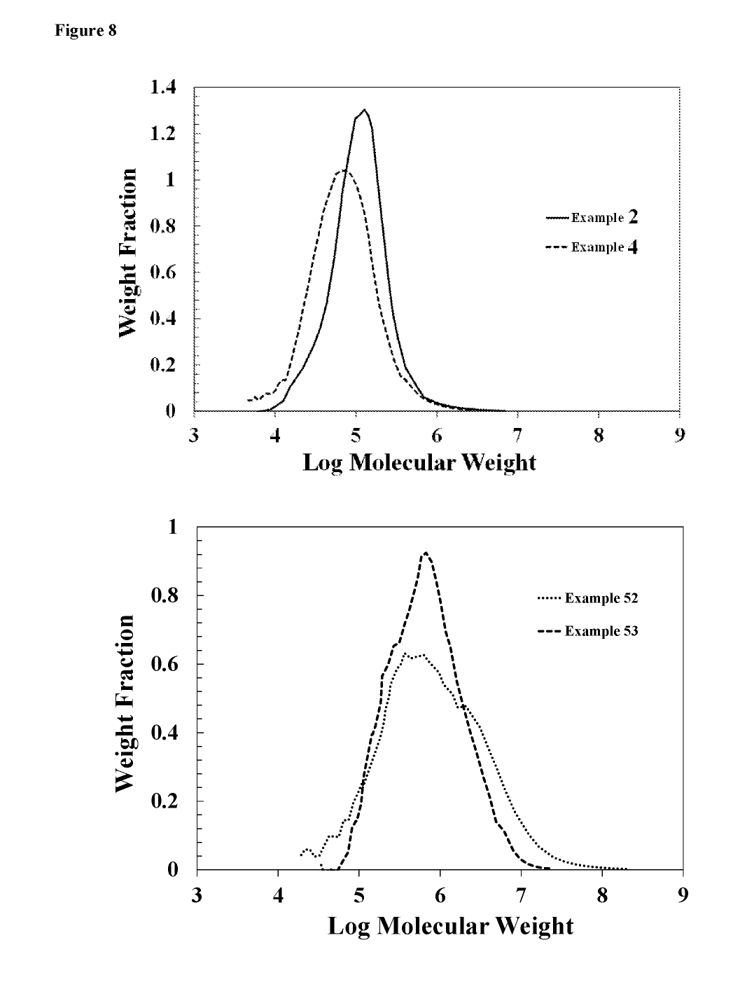

Gel permeation chromatography was performed on Examples 2 and 4; results are shown in FIG. 8.

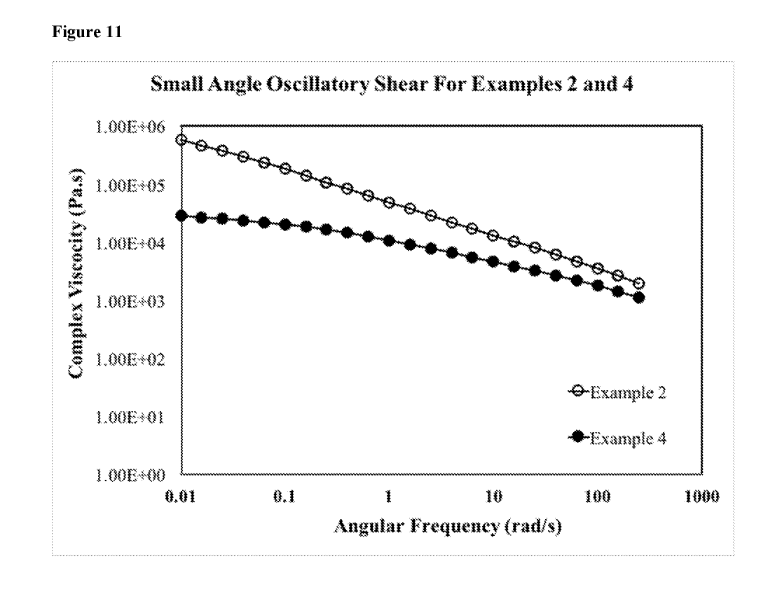

Complex viscosity data was obtained for Examples 2 and 4 using small angle oscillatory shear (SAOS); results are shown in FIG. 11.

### Examples 5-10

Examples 5, 6, and 7 are exemplary blended compositions made using a UHMWPE polyethylene having a molecular weight of 5×10⁶ g/mol (Lupolen UHM 5000, LyondellBasell Industries N.V., Houston, Tex.) and a high density polyethylene (HDPE) (Marval natural HDPE lot 2015-16112) (Marval Industries, Inc., Mamaroneck, N.Y.). These three examples were prepared using the General Process. Test specimens were injection molded into shapes according to their appropriate analysis as specified by the test method.

Examples 8, 9, and 10 were prepared by blending material described in Example 4 with another polymer. The compositions, characterized in Table 2, were feed using a K-Tron volumetric feeder (K2T60) into a 50 hp, 63.5 mm Welex Model 250 single-screw melt extruder having an L/D of 24/1. The barrel, die adaptor, and die head temperatures were maintained at 260° C. (500° F.), 274° C. (525° F.), and 282° C. (540° F.) for polypropylene (PP), nylon, and polyethylene terephthalate (PET) respectively. Test specimens were injection molded into shapes according to their appropriate analysis as specified by the test method.

TABLE 1
Mechanical and physical data for various examples of processed polymer compositions.

| | | MFI | | | | | |
|---|---|---|---|---|---|---|---|
| | | (g/10 min | | | Tensile | | |
| | | at | Young's | Yield | Stress at | | Notched |
| | | 190° C. | Modulus | Strength | Break | Elongation | Izod |
| | | and 2.16 kg) | (KSI) | (PSI) | (PSI) | at Break | (ft-lb/in) |
| | | ASTM | ASTM | ASTM | ASTM | (%) | ASTM |
| | Process | D-1238- | D-638- | D-638- | D-638- | ASTM | D-256- |
| Example | Temperature | 13 | 14 | 14 | 14 | D-638-14 | 10 |
| 1 | Compression | No Flow | 104 +/− 15 | 2900 +/− 100 | 2900 +/− 80 | 45 +/− 10 | No |
| | molded | | | | | | Break |
| | UHMWPE | | | | | | |
| | control | | | | | | |
| 2 | 338° C. | 0.2 | 161 +/− 12 | 3740 +/− 120 | 2700 +/− 200 | >300 | No |
| | (640° F.) | | | | | | Break |
| 3 | 341° C. | 0.4 | 150 +/− 15 | 3810 +/− 120 | 2500 +/− 200 | >300 | No |
| | (645° F.) | | | | | | Break |
| 4 | 343° C. | 1.7 | 164 +/− 14 | 3780 +/− 90 | 2200 +/− 100 | >300 | No |
| | (650° F.) | | | | | | Break |

| | Izod | Abrasion | | | | | |
|---|---|---|---|---|---|---|---|
| | Double | Resistance | | | | | |
| | Notch | (compared | | | Mw | Mn | |
| | (15°) (ft- | to | Static | Dynamic | (g/mol × | (g/mol × | |
| | lb/in²) | UHMWPE) | Coefficient | Coefficient | 1000) | 1000) | PDI |
| | ASTM | method | of Friction | of Friction | method | method | method |
| | D-4020- | described | ASTM | ASTM | described | described | described |
| Example | 11 | herein | D-1894-14 | D-1894-14 | herein | herein | herein |
| 1 | | Same¹ | | | 2,500 | 290 | 8.6 |
| 2 | 33.5 +/− 0.4 | Same¹⁻ | 0.19 | 0.17 | 160 | 76 | 2.1 |
| 3 | | | | | | | |
| 4 | 9.6 +/− 0.2 | Same¹ | 0.19 | 0.17 | 95 | 44 | 2.2 |

¹Differences were statistically insignificant.

TABLE 2
Mechanical and physical data for various examples of polymer blends.

| | | MFI | | | | |
|---|---|---|---|---|---|---|
| | | (g/10 min | Young's | | | Elongation |
| | | at 190° C. | Modulus | Yield Strength | Tensile Stress | at Break |
| | | and 2.16 kg) | (KSI) | (PSI) | at Break (PSI) | (%) |
| | Blend Ratio | ASTM D- | ASTM | ASTM | ASTM | ASTM |
| Example | (wt %/wt %) | 1238-13 | D-638-14 | D-638-14 | D-638-14 | D-638-14 |
| 5 | 75/25 | No flow | 160 +/− 4 | 3970 +/− 60 | 2850 +/− 150 | 60 +/− 4 |
| | UHMWPE/HDPE | | | | | |
| 6 | 75/25 | 1.5 | 137 +/− 2 | 3530 +/− 20 | 1760 +/− 20 | >500 |
| | UHMWPE/ | | | | | |
| | HDPE | | | | | |
| 7 | 85/25 UHMWPE/HDPE | 1.2 | 140 +/− 20 | 3810 +/− 120 | 2100 +/− 200 | >500 |
| 8 | 80/20 Example 4 | 13* | | | | |
| | material/PP | | | | | |
| 9 | 80/20 Example 4 | 4.7** | | | | |
| | material/Nylon | | | | | |
| 10 | 80/20 Example 4 | 46*** | | | | |
| | material/PET | | | | | |

| | Notched | Izod Double | Abrasion Resistance | Static | Dynamic |
|---|---|---|---|---|---|
| | Izod | Notch (15°) | (compared to | Coefficient of | Coefficient of |
| | (ft-lb/in) | (ft-lb/in²) | UHMWPE) | Friction | Friction |
| | ASTM | ASTM D- | method described | ASTM | ASTM |
| Example | D-256-10 | 4020-11 | herein | D-1894-14 | D-1894-14 |
| 5 | No Break | 55.7 +/− 1 | Same¹ | | |
| 6 | No Break | 8.6 | Same¹ | 0.17 | 0.15 |
| 7 | | | | | |
| 8 | | | | | |
| 9 | | | | | |
| 10 | | | | | |

*Test run at 230° C.and 2.16 kg.
**Test run at 235° C. and 1 kg
***Test run at 265° C. and 2.16 kg.
¹Differences were statistically insignificant.

### Examples 11-51

A solid polymer blend of UHMWPE starting polymer composition and another non-UHMWPE polymer and/or polymers may be made using the General Process. More specifically, the UHMWPE starting polymer composition may be blended with non-UHMWPE polymer simultaneously in a single or twin-screw melt extruder. The UHMWPE starting polymer composition will have a molecular weight of at least 7.5×10⁵ g/mol. In some embodiments, the resulting composition will include 0.1 to 99.9 wt % of the blend. In some embodiments, the resulting composition preferably will consist of 0.1 to 99.9 wt % of the blend.

Table 3 provides various blend ratios.

TABLE 3
Contemplated polymers blends

| Example | UHMWPE | HDPE | PP | Nylon 6 | PET | TPU | PVC | PTFE | POM |
|---|---|---|---|---|---|---|---|---|---|
| 11 | 99 | 1 | | | | | | | |
| 12 | 75 | 25 | | | | | | | |
| 13 | 50 | 50 | | | | | | | |
| 14 | 25 | 75 | | | | | | | |
| 15 | 1 | 99 | | | | | | | |
| 16 | 99 | | 1 | | | | | | |
| 17 | 75 | | 25 | | | | | | |
| 18 | 50 | | 50 | | | | | | |
| 19 | 25 | | 75 | | | | | | |
| 20 | 1 | | 99 | | | | | | |
| 21 | 99 | | | 1 | | | | | |
| 22 | 75 | | | 25 | | | | | |
| 23 | 50 | | | 50 | | | | | |
| 24 | 25 | | | 75 | | | | | |
| 25 | 1 | | | 99 | | | | | |
| 26 | 99 | | | | 1 | | | | |
| 27 | 75 | | | | 25 | | | | |
| 28 | 50 | | | | 50 | | | | |
| 29 | 25 | | | | 75 | | | | |
| 30 | 1 | | | | 99 | | | | |
| 31 | 99 | | | | | 1 | | | |
| 32 | 75 | | | | | 25 | | | |
| 33 | 50 | | | | | 50 | | | |
| 34 | 25 | | | | | 75 | | | |
| 35 | 1 | | | | | 99 | | | |
| 36 | 99 | | | | | | 1 | | |
| 37 | 75 | | | | | | 25 | | |
| 38 | 50 | | | | | | 50 | | |
| 39 | 25 | | | | | | 75 | | |
| 40 | 1 | | | | | | 99 | | |
| 41 | 99 | | | | | | | 1 | |
| 42 | 75 | | | | | | | 25 | |
| 43 | 50 | | | | | | | 50 | |
| 44 | 25 | | | | | | | 75 | |
| 45 | 1 | | | | | | | 99 | |
| 46 | 99 | | | | | | | | 1 |
| 47 | 75 | | | | | | | | 25 |
| 48 | 50 | | | | | | | | 50 |
| 49 | 25 | | | | | | | | 75 |
| 50 | 1 | | | | | | | | 99 |
| 51 | 20 | 10 | 10 | 10 | 10 | 10 | 10 | 10 | 10 |

### Example 52

In this comparative example, which shows the properties of UHMWPE not processed according to the methods described herein, compression molded polyethylene was prepared by placing 34 grams of UHMWPE powder (Lupolen UHM 5000, LyondellBasell Industries N.V., Houston, Tex.) in stainless steel mold. The mold was placed into a heated press (Carver model C, Carver, Inc., Wabash, Ind.) set to 190° C. The mold and its contents were placed under 100 psi of pressure then allowed to equilibrate for 10 minutes. After that time, the mold was moved to a second cold press (Carver model K, Carver, Inc., Wabash, Ind.) and placed under 20 tons of pressure. The mold was allowed to cool for another 10 minutes, at room temperature, after which the molded polyethylene was removed. Furthermore, the compression molded specimen was allowed to sit at room temperature for 48 hours before testing. Properties of the polyethylene are provided in Table 4.

FIG. 8 shows gel permeation chromatography data for the material of Example 52.

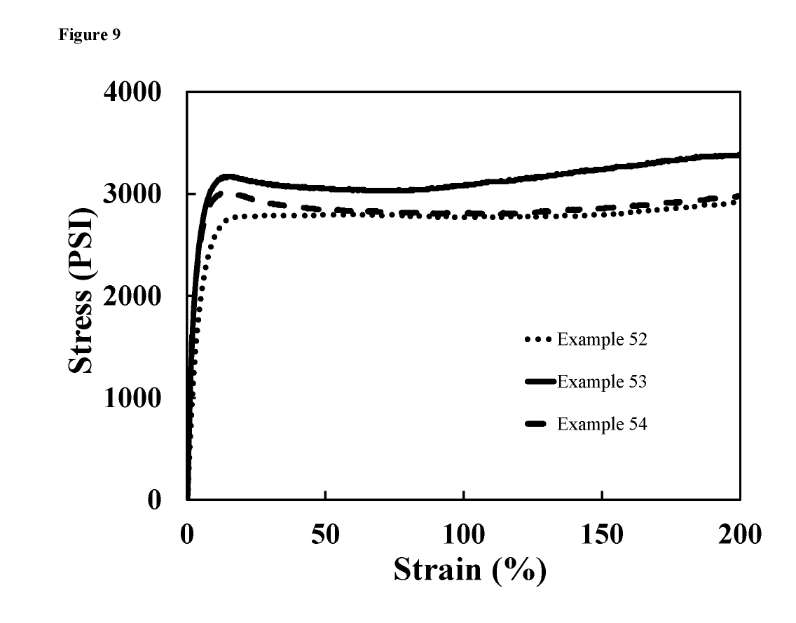

FIG. 9 shows stress versus strain data for the material of Example 52.

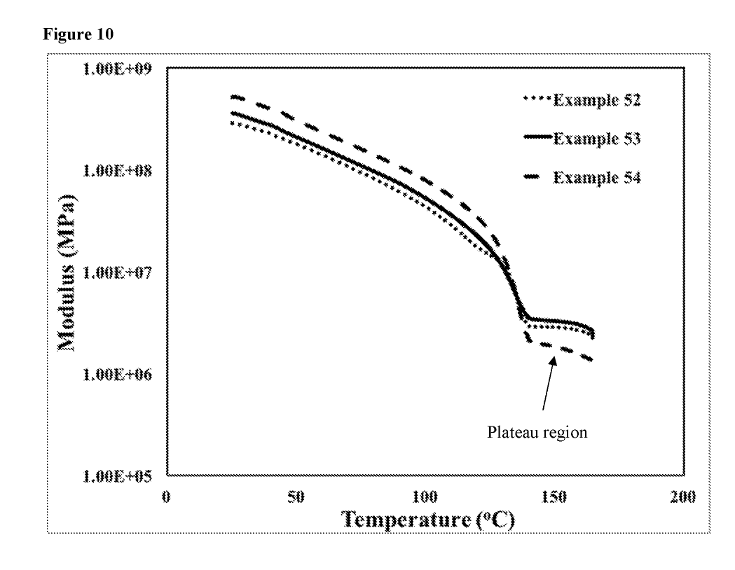

Storage modulus was measured using dynamic mechanical analysis; results are shown in FIG. 10.

### Examples 53 and 54

Polyethylene was prepared by feeding 50 pounds (lbs) of UHMWPE powder (Lupolen UHM 5000, LyondellBasell Industries N.V., Houston, Tex.) into a 150 horespower (hp) intermeshing, co-rotating twin-screw extruder (ZSK-70, Werner and Pfleiderer). The twin-screw extruder, or pulverizer, has a diameter (D) of 70 mm throughout its entire length and a length to diameter ratio (L/D) of 16. The screws are modular in nature and designed as a combination of spiral conveying and bilobe kneading or pulverization elements. A harsh screw configuration including more than three neutral and reverse pulverization elements is employed.

Throughout the process duration, the barrels and shafts are cooled by recirculating a propylene glycol/water (40/60 vol/vol) mixture maintained at −5° C. to 35° C. (23° F. to 95° F.) by a chiller with a 30 ton Copeland compressor. The flow rate of coolant through the pulverization apparatus is set at 20 gpm to 30 gpm. The screw rotation speed is maintained constant at 200 rpm, imparting a load on the motor of 30% to 35%. Material is fed into the pulverization apparatus at room temperature, or 25° C. (77° F.), using a Schenk volumetric feeder. The material passes through the pulverizer at a rate of 75 kg/hr and increases in temperature so that once exiting the pulverizer it has increased in its temperature in a range of 125° C. to 230° C. (257° F. to 446° F.). An energy meter on the coolant system indicates that 120 kBTU/hr to 140 kBTU/hr is removed from the pulverizer during steady state processing.

Example 53 was prepared as described above, then ground to a 300 μm powder for molding. Example 54 was prepared by feeding 25 lbs of the material prepared as described above through the process for a second pulverization pass. Following pulverization, the material was ground to a 300 μm powder for molding.

Compression molded specimens of sheared polymer were prepared by placing 34 grams of ground powder in a stainless steel mold. The mold was placed into a heated press (Carver model C, Carver, Inc., Wabash, Ind.) set to 190° C. The mold and its contents were placed under 100 psi of pressure then allowed to equilibrate for 10 minutes. After that time, the mold was moved to a second cold press (Carver model K, Carver, Inc., Wabash, Ind.) and placed under 20 tons of pressure. The mold was allowed to cool for another 10 minutes, at room temperature, after which the molded polyethylene was removed. Furthermore, the compression molded specimen was allowed to sit at room temperature for 48 hours before testing. Properties of the polyethylene are provided in Table 4.

FIG. 8 shows gel permeation chromatography data for the material of Examples 53 and 54.

FIG. 9 shows stress versus strain data for the material of Examples 53 and 54.

Storage modulus was measured using dynamic mechanical analysis; results are shown in FIG. 10.

TABLE 4
Mechanical and physical data for various examples of sheared polymer compositions.

| | | MFI | | | Tensile | |
|---|---|---|---|---|---|---|
| | | (g/10 min at | Young's | Yield | Stress at | Elongation |
| | | 190° C. and | Modulus | Strength | Break | at Break |
| | | 2.16 kg) | (KSI) | (PSI) | (PSI) | (%) |
| | | ASTM | ASTM | ASTM | ASTM | ASTM |
| Example | Description | D-1238-13 | D-638-14 | D-638-14 | D-638-14 | D-638-14 |
| 52 | Compression | No Flow | 51.6 +/− 3.0 | 2742 +/− 29 | 3362 +/− 441 | 290 +/− 99 |
| | molded | | | | | |
| | control | | | | | |
| 53 | 1-pass | No Flow | 63.9 +/− 6.1 | 3010 +/− 186 | 3133 +/− 168 | 224 +/− 30 |
| | pulverization | | | | | |
| 54 | 2-pass | No Flow | 67.6 +/− 0.9 | 3056 +/− 78 | 4153 +/− 179 | 402 +/− 44 |
| | pulverization | | | | | |

| | | | Abrasion | | | |
|---|---|---|---|---|---|---|
| | | | Resistance | Mw | Mn | |
| | Notched | Izod Double | (compared to | (g/mol × | (g/mol × | |
| | Izod | Notch (15°) | UHMWPE) | 1000) | 1000) | PDI |
| | (ft-lb/in) | (ft-lb/in²) | method | method | method | method |
| | ASTM | ASTM | described | described | described | described |
| Example | D-256-10 | D-4020-11 | herein | herein | herein | herein |
| 52 | No Break | 59.7 +/− 5.7 | Same¹ | 2,500 | 290 | 8.6 |
| 53 | No Break | 55 +/− 1.5 | Same¹ | 980 | 270 | 3.6 |
| 54 | No Break | 46.8 +/− 2.1 | Same¹ | 890 | 270 | 3.3 |

¹Differences were statistically insignificant.

### Examples 55-59

A solid polymer blend of a UHMWPE starting polymer composition including more than one UHMWPE starting polymer may be made using the General Process to form a sheared polymer and/or a processed polymer. In some cases, the weight average molecular weights of the two polymers may be sufficiently different so as to result in a bimodal molecular weight distribution.

The compositions may be blended in a single or twin-screw melt extruder. The UHMWPE starting polymer composition will have a molecular weight of at least 7.5×10⁵ g/mol. In some embodiments, the resulting composition will include 0.1 to 99.9 wt % of the blend. In some embodiments, the resulting composition preferably will consist of 0.1 to 99.9 wt % of the blend.

Table 5 provides various blend ratios.

TABLE 5
Exemplary polymer blends

| Example | UHMWPE-1 | UHMWPE-2 |
|---|---|---|
| 55 | 99 | 1 |
| 56 | 75 | 25 |
| 57 | 50 | 50 |
| 58 | 25 | 75 |
| 59 | 1 | 99 |

The complete disclosure of all patents, patent applications, and publications, and electronically available material cited herein are incorporated by reference. In the event that any inconsistency exists between the disclosure of the present application and the disclosure(s) of any document incorporated herein by reference, the disclosure of the present application shall govern. The foregoing detailed description and examples have been given for clarity of understanding only. No unnecessary limitations are to be understood therefrom. The invention is not limited to the exact details shown and described, for variations obvious to one skilled in the art will be included within the invention defined by the claims.

All headings are for the convenience of the reader and should not be used to limit the meaning of the text that follows the heading, unless so specified.

1. (canceled)

2-37. (canceled)

38. A method comprising:
applying a shear force to a starting polymer composition comprising a polyolefin having a weight average molecular weight (M_{w}) of at least 7.5×10⁵ g/mol to form a sheared polymer composition,
wherein applying shear force to the starting polymer composition comprises applying a shear force while repeatedly raising the temperature of and then cooling the starting polymer composition, and
further wherein applying shear force to the starting polymer composition comprises applying a shear force while heating the polymer composition to a temperature greater than the melting point of the lowest melting point of a polymer in the polymer composition.

39. The method of claim 38, wherein applying a shear force to a starting polymer composition does not comprise solid-state shear pulverization (SSSP).

40. The method of claim 38, wherein the polymer composition is heated by the application of the shear force to the polymer composition.

41. The method of claim 38, wherein the method further comprises treating the sheared polymer composition to produce a processed polymer composition.

42. The method of claim 41, wherein producing a processed polymer composition comprises pelletizing the processed polymer composition.

43. The method of claim 41, wherein treating the sheared polymer composition to form the processed polymer composition changes the weight average molecular weight (M_{w}) of the sheared polymer up to 20%.

44. The method of claim 41, wherein treating the sheared polymer composition to form the processed polymer composition does not change the z average molecular weight (M_{z}) of the sheared polymer more than 10%.

45. The method of claim 41, wherein treating the sheared polymer composition to form the processed polymer composition does not comprise heating the sheared polymer composition.

46. The method of claim 41, wherein treating the sheared polymer composition to form the processed polymer composition comprises heating the sheared polymer composition to a temperature up to 100° C. greater than the melting point of the starting polymer composition

47. The method of claim 38, wherein treating the sheared polymer composition comprises heating the sheared polymer composition to a temperature of up to 500° C.

48. The method of claim 38, wherein treating the sheared polymer composition comprises applying a shear force to the sheared polymer composition.

49. A method comprising:
applying a shear force to a starting polymer composition comprising a combination of polymers to form a sheared polymer composition,
wherein the polymer composition comprises a first polymer and a second polymer, the first polymer comprising a polyolefin having a weight average molecular weight (M_{w}) of at least 7.5×10⁵ g/mol,
wherein applying shear force to the starting polymer composition comprises applying a shear force while repeatedly raising the temperature of and then cooling the starting polymer composition, and
further wherein applying shear force to the starting polymer composition comprises applying a shear force while heating the polymer composition to a temperature greater than the melting point of the lowest melting point of a polymer in the polymer composition.

50. The method of claim 49, wherein the second polymer comprises at least one of a polyolefin; a polytetrafluoroethylene; a polystyrene; a polyvinylchloride; and a polyester.

51. The method of claim 49, wherein the second polymer comprises at least one of HDPE, PP, Nylon 6, PET, TPU, PVC, PTFE, and POM.

52. The method of claim 49, wherein the second polymer has a weight average molecular weight (M_{w}) of less than 7.5×10⁵ g/mol.

53. The method of claim 49, wherein applying a shear force to a starting polymer composition does not comprise solid-state shear pulverization (SSSP).
